(19) United States
(12) Patent Application Publication
(10) Pub. No.: US 2022/0217679 A1
(43) Pub. Date: Jul. 7, 2022

(54) METHOD PERFORMED BY USER EQUIPMENT, AND USER EQUIPMENT

(71) Applicant: SHARP KABUSHIKI KAISHA, Sakai City, Osaka (JP)

(72) Inventors: Yinan Zhao, Shanghai (CN); RENMAO LIU, Shanghai (CN); CHAO LUO, Shanghai (CN)

(21) Appl. No.: 17/607,812

(22) PCT Filed: Apr. 26, 2020
(86) PCT No.: PCT/CN2020/086969

§ 371 Date: Oct. 29, 2021

(30) Foreign Application Priority Data
Apr. 30, 2019 (CN) 201910366544.2

(51) Int. Cl. H04W 72/02; H04W 72/04; H04W 28/26; H04L 1/08

(52) U.S. Cl. CPC H04W 72/02; H04W 72/0406; H04L 1/08; H04W 28/26; H04W 72/0446

(57) ABSTRACT

The present invention provides a method performed by user equipment and user equipment. The method comprises: receiving sidelink control information (SCI) transmitted by other user equipment; and determining a resource for at least any one of an initial transmission, a blind retransmission, and a retransmission of a transport block (TB) carried by a physical sidelink shared channel (PSSCH) corresponding to the SCI.

### TECHNICAL FIELD

The present invention relates to the technical field of wireless communications, and in particular to a method performed by user equipment, a method performed by a base station, and corresponding user equipment.

### BACKGROUND

In conventional cellular networks, all communication needs to be forwarded via base stations. By contrast, D2D communication (device-to-device communication, device-to-device direct communication) refers to a direct communication method between two pieces of user equipment without forwarding via a base station or a core network. A research project on the use of LTE equipment to implement proximity D2D communication services was approved at the 3rd Generation Partnership Project (3GPP) RAN #63 plenary meeting in March 2014 (see Non-Patent Document 1). Functions introduced in the LTE Release 12 D2D include:

1) a discovery function between proximate devices in an LTE network coverage scenario;

2) a direct broadcast communication function between proximate devices; and

3) support for unicast and groupcast communication functions at higher layers.

A research project on enhanced LTE eD2D (enhanced D2D) was approved at the 3GPP RAN #66 plenary meeting in December 2014 (see Non-Patent Document 2). Main functions introduced in the LTE Release 13 eD2D include:

1) a D2D discovery in out-of-coverage and partial-coverage scenarios; and

2) a priority handling mechanism for D2D communication.

Based on the design of the D2D communication mechanism, a V2X feasibility research project based on D2D communication was approved at the 3GPP RAN #68 plenary meeting in June 2015. V2X stands for Vehicle to Everything, and intends to implement information exchange between a vehicle and all entities that may affect the vehicle, for the purpose of reducing accidents, alleviating traffic congestion, reducing environmental pollution, and providing other information services. Application scenarios of V2X mainly include four aspects:

1) V2V, Vehicle to Vehicle, vehicle-to-vehicle communication;

2) V2P, Vehicle to Pedestrian, i.e., a vehicle transmits alarms to a pedestrian or a non-motorized vehicle;

3) V2N: Vehicle-to-Network, i.e., a vehicle connects to a mobile network;

4) V2I: Vehicle-to-Infrastructure, i.e., a vehicle communicates with road infrastructure.

3GPP divides the research and standardization of V2X into three stages. The first stage was completed in September 2016, and was mainly focused on V2V and based on LTE Release 12 and Release 13 D2D (also known as sidelink communication), that is, the development of proximity communication technologies (see Non-Patent Document 3). V2X stage 1 introduced a new D2D communication interface referred to as PC5 interface. The PC5 interface is mainly intended to address the issue of cellular Internet of Vehicle (IoV) communication in high-speed (up to 250 km/h) and high-node density environments. Vehicles can exchange information such as position, speed, and direction through the PC5 interface, that is, the vehicles can communicate directly through the PC5 interface. Compared with the proximity communication between D2D devices, functions introduced in LTE Release 14 V2X mainly include:

1) higher density DMRS to support high-speed scenarios;

2) introduction of sub-channels to enhance resource allocation modes; and

3) introduction of a user equipment sensing mechanism with semi-persistent scheduling.

The second stage of the V2X research project belonged to the LTE Release 15 research category (see Non-Patent Document 4). Main features introduced included high-order 64QAM modulation, V2X carrier aggregation, short TTI transmission, as well as feasibility study of transmit diversity.

The corresponding third stage, V2X project based on 5G NR network technologies (see Non-Patent Document 5), was approved at the 3GPP RAN #83 plenary meeting in March 2019. The research plan of this project includes the design of a sidelink resource allocation method (or referred to as a sidelink transmission mode). At the 3GPP RAN1#94 meeting in August 2018 (see Non-Patent Document 6), sidelink communication includes at least two resource allocation modes, which are respectively referred to as Mode 1, a resource allocation mode based on base station scheduling, and Mode 2, a resource allocation mode of determining sidelink resources by UE, The specific definitions of Mode 1 and Mode 2 are:

1) Mode 1: a base station schedules resources used by UE for sidelink communication; and
2) Mode 2: UE determines, by sensing, resources used for sidelink communication in resources configured or pre-configured by a base station.

Among them, Mode 2 includes four sub-modes, which are defined as Mode 2(a), Mode 2(b), Mode 2(c), and Mode 2(d), respectively. The specific definitions of the four sub-modes included in Mode 2 are:

1) Mode 2(a): the UE selects resources for sidelink communication by the UE itself;

2) Mode 2(b): the UE assists other UE to select resources for sidelink communication;

3) Mode 2(c): the base station configures a UE NR type 1 configured grant (which may be referred to as CG for short); and

4) Mode 2(d): the UE schedules resources for other UE to perform sidelink communication.

Support for blind retransmission of one TB in NR sidelink communication was discussed and approved at the 3GPP RAN1#96 meeting in January 2019 (see Non-Patent Document 7). The blind retransmission of one TB indicates that retransmission of the TB is not based on HARQ retransmission, but direct retransmission, referred to as “blind retransmission”. Furthermore, it was discussed and determined at the RAN1 meeting to support UE to reserve transmission resources for blind retransmission of a TB in the NR sidelink transmission mode 2, indicating that the UE performs direct transmission without resource sensing and resource selection when performing the blind retransmission.

The solution of the present invention is mainly directed to a method for determining reserved resources of other UE for initial transmission and/or blind retransmission by resource sensing UE according to received SCI transmitted by the other UE in the NR sidelink transmission mode 2, and also includes a method for the resource sensing UE to exclude, from a candidate resource set, resources that overlap with the reserved resources of the other UE for the initial transmission and/or the blind retransmission.

In unicast and groupcast for an NR sidelink, an HARQ feedback-based retransmission mechanism is supported. A physical sidelink feedback channel (PSFCH) is introduced into the NR sidelink to carry HARQ feedback (or referred to as A/N feedback, ACK/NACK feedback) for the sidelink. At the 3G-PP RAN1#96bis meeting in April 2019 (see Non-Patent Document 8), the meeting reached the following conclusions with respect to PSFCH resource allocation:

a PSFCH is periodically configured in slots included in an NR sidelink resource pool, the configuration period is N slots, and possible numerical values of N include 1 and at least one integer greater than 1.

The solution of the present invention also includes a method for NR sidelink UE to determine a time-domain resource for transmitting a PSFCH.

### PRIOR ART DOCUMENT

### Non-Patent Documents

Non-Patent Document 1: RP-140518, Work item proposal on LTE Device to Device Proximity Services
Non-Patent Document 2: RP-142311, Work Item Proposal for Enhanced LTE Device to Device Proximity Services
Non-Patent Document 3: RP-152293, New WI proposal: Support for V2V services based on LTE sidelink
Non-Patent Document 4: RP-170798, New WID on 3GPP V2X Phase 2
Non-Patent Document 5: RP-190766, New WM on 5G V2X with NR sidelink
Non-Patent Document 6: RAN1#94, Chairman notes, section 7.2.4.1.4
Non-Patent Document 7: RAN1#96, Chairman notes, section 7.2.4.1.4
Non-Patent Document 8: RAN1496bis, Chairman notes, section 7.2.4.5

### SUMMARY OF INVENTION

In order to solve at least part of the aforementioned problems, the present invention provides a method performed by user equipment and user equipment, which make it possible to determine a resource for at least any one of an initial transmission, a blind retransmission, and a retransmission of other user equipment according to received. SCI transmitted by the other user equipment, and to further determine a reserved resource corresponding to the at least any one transmission, and to further exclude, from a candidate resource set or a resource set, a resource that overlaps with the determined resource or reserved resource.

According to a first aspect of the present invention, proposed is a method performed by user equipment, including: receiving sidelink control information (SCI) transmitted by other user equipment; and determining a resource for at least any one of an initial transmission, a blind retransmission, and a retransmission of a transport block (TB) carried by a physical sidelink shared channel (PSSCH) corresponding to the SCI.

In the foregoing method, it is possible that the SCI includes indication information indicating that the TB is transmitted in the initial transmission, and a time domain gap between the initial transmission and the blind retransmission or the retransmission, and a resource for one or multiple blind retransmissions or one or multiple retransmissions of the TB is determined according to the time domain gap.

In the foregoing method, it is possible that the SCI includes indication information indicating that the TB is transmitted in the blind retransmission, and a time domain gap between blind retransmissions or between the initial transmission and the blind retransmission, and a resource for one or multiple other blind retransmissions or initial transmissions of the TB is determined according to the time domain gap.

In the foregoing method, it is possible that the SCI includes indication information indicating that the TB is transmitted in the retransmission, and a time domain gap between retransmissions or between the initial transmission and the retransmission, and a resource for one or multiple other retransmissions or initial transmissions of the TB is determined according to the time domain gap.

In the foregoing method, it is possible that the method further includes determining a reserved resource corresponding to the at least any one of the initial transmission, the blind retransmission, and the retransmission of the TB.

In the foregoing method, it is possible that the SCI further includes an indication of a reserved resource interval, and the reserved resource corresponding to the at least any one of the initial transmission, the blind retransmission, and the retransmission of the TB is determined according to the reserved resource interval.

In the foregoing method, it is possible that the method further includes: receiving another piece of SCI comprising indication information of a reserved resource interval and corresponding to the at least any one of the initial transmission, the blind retransmission, and the retransmission of the TB; and determining, according to the reserved resource interval, the reserved resource corresponding to the at least any one of the initial transmission, the blind retransmission, and the retransmission of the TB.

According to a second aspect of the present invention, proposed is a method performed by user equipment, including: receiving sidelink control information (SCI) transmitted by other user equipment, the SCI comprising an indication of a reserved resource interval, and/or an indication of a number of reserved resources; and determining one or multiple reserved resources of the other user equipment according to the indication of the reserved resource interval and/or the number of reserved resources.

In the foregoing method, it is possible that the method further includes: excluding from a candidate resource set or a resource set a resource that overlaps with the resource or the reserved resource determined by the user equipment.

According to a third aspect of the present invention, proposed is user equipment, including: a processor; and a memory, storing instructions, where the instructions, when run by the processor, perform the foregoing method.

### Effect of Invention

According to the method performed by user equipment and the user equipment of the present invention, it is possible to determine a resource for at least any one of an initial transmission, a blind retransmission, and a retransmission of other user equipment according to received SCI transmitted by the other user equipment, and to further determine a reserved resource corresponding to the at least any one transmission, and to further exclude, from a candidate resource set or a resource set, a resource that overlaps with the determined resource or reserved resource, thereby improving the resource utilization efficiency of an entire communication system and reducing the transmission collision probability between user equipment.

### BRIEF DESCRIPTION OF THE DRAWINGS

The above and other features of the present invention will be more pronounced through the following detailed description taken in conjunction with the accompanying drawings.

FIG. 1 schematically shows a basic procedure of LTE V2X sidelink communication in the existing 3GPP standard specifications.

FIG. 2 schematically shows two resource allocation modes (transmission modes) of LTE V2X in the existing 3GPP standard specifications.

FIG. 3 is a diagram schematically showing a basic procedure of a user equipment method of the present invention.

FIG. 4 is a diagram schematically showing another basic procedure of a user equipment method of the present invention.

FIG. 5 is a diagram schematically showing a basic procedure of a user equipment method according to Embodiment 1 of the present invention.

FIG. 6 is a diagram schematically showing a basic procedure of a user equipment method according to Embodiment 2 of the present invention.

FIG. 7 is a diagram schematically showing a basic procedure of a user equipment method according to Embodiment 3 of the present invention.

FIG. 8 is a diagram schematically showing a basic procedure of a user equipment method according to Embodiment 4 of the present invention.

FIG. 9 is a diagram schematically showing a basic procedure of a user equipment method according to Embodiment 5 of the present invention.

FIG. 10 is a diagram schematically showing a basic procedure of a user equipment method according to Embodiment 6 of the present invention.

FIG. 11 is a diagram schematically showing a basic procedure of a user equipment method according to Embodiment 7 of the present invention.

FIG. 12 is a diagram schematically showing a basic procedure of a user equipment method according to Embodiment 8 of the present invention.

FIG. 13 is a diagram schematically showing a basic procedure of a user equipment method according to Embodiment 9 of the present invention.

FIG. 14 is a diagram schematically showing a basic procedure of a user equipment method according to Embodiment 10 of the present invention.

FIG. 15 is a diagram schematically showing a basic procedure of a user equipment method according to Embodiment 11 of the present invention.

FIG. 16 is a diagram schematically showing a basic procedure of a user equipment method according to Embodiment 12 of the present invention.

FIG. 17 is a diagram schematically showing a basic procedure of a user equipment method according to Embodiment 13 of the present invention.

FIG. 18 is a diagram schematically showing a basic procedure of a user equipment method according to Embodiment 14 of the present invention.

FIG. 19 is a block diagram schematically showing user equipment according to an embodiment of the present invention.

### DETAILED DESCRIPTION

The following describes the present invention in detail with reference to the accompanying drawings and specific embodiments. It should be noted that the present invention is not limited to the specific embodiments described below. In addition, for simplicity, detailed description of the known art not directly related to the present invention is omitted to prevent confusion with respect to the understanding of the present invention.

In the following description, a 5G mobile communication system and its subsequently evolved versions are used as illustrative application environments to set forth a plurality of embodiments according to the present invention in detail. However, it is to be noted that the present invention is not limited to the following embodiments, and rather, it is applicable to many other wireless communication systems, such as a communication system later than 5G and a 4G mobile communication system earlier than the 5G.

Some terms involved in the present invention are described below. Unless otherwise specified, the terms used in the present invention adopt the definitions herein.

The terms given in the present invention may be named differently in LTE, LTE-Advanced, LTE-Advanced Pro, NR, and later communication systems, but unified terms are adopted in the present invention. When applied to a specific system, the terms may be replaced with terms adopted in the corresponding system.

3GPP: 3rd Generation Partnership Project

LTE: Long Term Evolution

NR: New Radio

PDCCH: Physical Downlink Control Channel

DCI: Downlink Control Information

PDSCH: Physical Downlink Shared Channel

UE: User Equipment

eNB: evolved NodeB, evolved base station

gNB: NR base station

TTI: Transmission Time Interval

TB: Transport Block

OFDM: Orthogonal Frequency Division Multiplexing

C-RNTI: Cell Radio Network Temporary Identifier

CSI: Channel State Indicator

HARQ: Hybrid Automatic Repeat Request

CSI-RS: CSI-Reference Signal, channel state measurement reference signal

CRS: Cell Reference Signal

PUCCH: Physical Uplink Control Channel

PUSCH: Physical Uplink Shared Channel

UL-SCH: Uplink Shared Channel

CG: Configured Grant

Sidelink: Sidelink communication

SCI: Sidelink Control Information

PSCCH: Physical Sidelink Control Channel

MCS: Modulation and Coding Scheme

CRB: Common Resource Block

CP: Cyclic Prefix

PRB: Physical Resource Block

PSSCH: Physical Sidelink Shared Channel

FDM: Frequency Division Multiplexing

RRC: Radio Resource Control

RSRP: Reference Signal Receiving Power

SRS: Sounding Reference Signal

DMRS: Demodulation Reference Signal

CRC: Cyclic Redundancy Check

PSDCH: Physical Sidelink Discovery Channel

PSBCH: Physical Sidelink Broadcast Channel

SFI: Slot Format Indication

TDD: Time Division Duplexing

FDD: Frequency Division Duplexing

SIB1: System Information Block Type 1

SLSS: Sidelink Synchronization Signal

PSSS: Primary Sidelink Synchronization Signal

SSSS: Secondary Sidelink Synchronization Signal

PCI: Physical Cell ID

PSS: Primary Synchronization Signal

SSS: Secondary Synchronization Signal

BWP: Bandwidth Part

GNSS: Global Navigation Satellite System

SFN: System Frame Number (radio frame number)

DFN: Direct Frame Number

IE: Information Element

SSB: Synchronization Signal Block

EN-DC: EUTRA-NR Dual Connection

MCG: Master Cell Group

SCG: Secondary Cell Group

PCell: Primary Cell

SCell: Secondary Cell

PSFCH: Physical Sidelink Feedback Channel

SPS: Semi-Persistent Scheduling

TA: Timing Advance

RV: Redundancy Version

The following is a description of the prior art associated with the solution of the present invention. Unless otherwise specified, the same terms in the specific embodiments have the same meanings as in the prior art.

It is worth pointing out that the V2X and sidelink mentioned in the description of the present invention have the same meaning. The V2X herein can also mean sidelink; similarly, the sidelink herein can also mean V2X, and no specific distinction and limitation will be made in the following text.

The resource allocation mode of V2X (sidelink) communication and the transmission mode of V2X (sidelink) communication in the description of the present invention can be replaced equivalently. The resource allocation mode involved in the description can mean transmission mode, and the transmission mode involved can mean resource allocation mode.

In the description of the present invention, the index of a resource, including but not limited to, an initial transmission resource, a blind retransmission resource, a retransmission resource, and a reserved resource, refers to an index (which may be a subscript or a superscript in a type of identifier) on an NR sidelink available resource, or may refer to an index (which may be a subscript or a superscript in a type of identifier) on a resource pool of user equipment.

In the description of the present invention, a blind retransmission refers to a direct retransmission not based on HARQ feedback, and a retransmission refers to a retransmission based on HARQ feedback, and the HARQ feedback is ACK/NACK feedback or NACK feedback. An initial transmission refers to the first transmission of a certain transport block (TB), briefly referred to as initial transmission.

In the description of the present invention, other user equipment refers to a certain piece of other user equipment or a plurality of pieces of other user equipment that are different from the user equipment.

### Sidelink Communication Scenario

1) Out-of-coverage sidelink communication: Both pieces of UE performing sidelink communication are out of network coverage (for example, the UE cannot detect any cell that meets a “cell selection criterion” on a frequency at which sidelink communication needs to be performed, and that means the UE is out of network coverage).

2) In-coverage sidelink communication: Both pieces of UE performing sidelink communication are in network coverage (for example, the UE detects at least one cell that meets a “cell selection criterion” on a frequency at which sidelink communication needs to be performed, and that means the UE is in network coverage).

3) Partial-coverage sidelink communication: One of two pieces of UE performing sidelink communication is out of network coverage, and the other is in network coverage.

From the perspective of a UE side, the UE has only two scenarios, out-of-coverage and in-coverage. Partial-coverage is described from the perspective of sidelink communication.

### NR V2X Unicast, Groupcast, and Broadcast

Existing LTE V2X communication only supports broadcast communication at a physical layer. Broadcast communication is widely applied in scenarios such as cellular communication where a base station transmits a system message to UE in a cell. The design goals of NR V2X include support for unicast communication and groupcast communication at a physical layer. Unicast communication refers to communication between transmitting user equipment (UE) and single receiving user equipment. Groupcast communication generally means that a group of UE are assigned the same identity (ID), among which UE transmits V2X data to other UE in the group, and receives V2X data transmitted by other UE in the group. It is worth pointing out that, in order to better improve the reliability of transmission and improve the spectrum efficiency, an HARQ retransmission mechanism is usually included in unicast communication and groupcast communication. HARQ stands for hybrid automatic repeat request, which can provide an error correction function and implement fast repeat request, and is widely applied in wireless data communications. HARQ feedback includes an HARQ ACK and an HARQ NACK. Among them, the HARQ ACK means that receiving UE correctly receives and decodes data of transmitting UE and therefore feeds back an HARQ ACK; the HARQ NACK means that the receiving UE does not correctly receive and decode the data of the transmitting UE. When the receiving UE feeds back an HARQ NACK, the transmitting UE may retransmit corresponding data to ensure improvement in the reliability of data communication. In NR V2X, the HARQ ACK and the HARQ NACK are carried by a Physical Sidelink Feedback Channel (PSFCH).

### Basic Procedure of LTE V2X (Sidelink) Communication

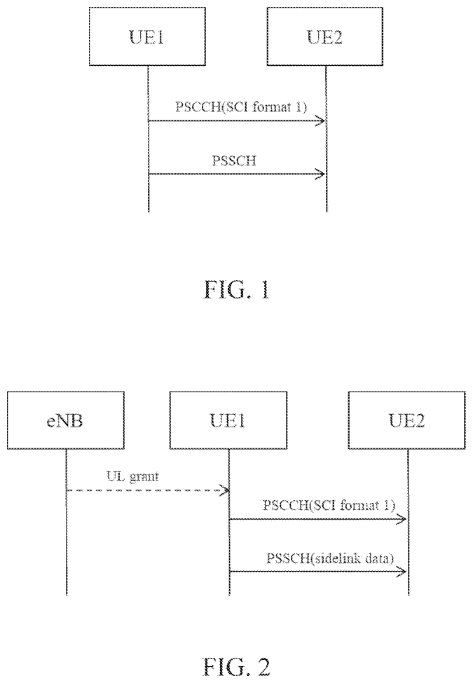

FIG. 1 shows a basic procedure of LTE V2X UE sidelink communication. First, UE1 transmits to UE2 sidelink control information (SCI format 1), which is carried by a physical layer channel PSCCH. The SCI format 1 includes scheduling information of the PSSCH, such as time domain and frequency domain resources, an MCS, and the like of the PSSCH. Secondly, the UE1 transmits to the UE2 sidelink data, which is carried by a physical layer channel PSSCH. The PSCCH and the corresponding PSSCH are frequency division multiplexed, that is, the PSCCH and the corresponding PSSCH are located in the same subframe in the time domain and are located on different PRBs in the frequency domain. Specific design methods of the PSCCH and the PSSCH are as follows:

1) The PSCCH occupies one subframe in the time domain and two consecutive PRBs in the frequency domain. Initialization of a scrambling sequence uses a predefined value 510. The PSCCH may carry SCI format 1, where the SCI format 1 at least includes time-frequency domain resource information of the PSSCH. For example, for a frequency domain resource indication field, the SCI format 1 indicates a starting sub-channel number and the number of consecutive sub-channels of the PSSCH corresponding to the PSCCH.

2) The PSSCH occupies one subframe in the time domain, and uses frequency division multiplexing (FDM) with the corresponding PSCCH. The PSSCH occupies one or multiple consecutive sub-channels in the frequency domain. The sub-channel represents n_{subCHsize} consecutive PRBs in the frequency domain. n_{subCHsize} is configured by an RRC parameter, and the number of sub-channels is indicated by the frequency domain resource indication field of the SCI format 1.

LTE V2X resource allocation mode: Transmission Mode 3/4 (in eNB network coverage)

FIG. 2 shows two resource allocation modes of LTE V2X in eNB network coverage on a frequency for sidelink communication, which are referred to as base station scheduling-based resource allocation (Transmission Mode 3) and UE sensing-based resource allocation (Transmission Mode 4). In LTE V2X, in eNB network coverage, a base station can configure, through UE-specific dedicated RRC signaling SL-V2X-ConfigDedicated, a resource allocation mode of the UE, or referred to as a transmission mode of the UE, which is specifically as follows:

1) Base station scheduling-based resource allocation mode (Transmission Mode 3): The base station scheduling-based resource allocation mode means that time domain and frequency domain resources used for sidelink communication are from scheduling of the base station. Specifically, when RRC signaling SL-V2X-ConfigDedicated is set to scheduled-r14, it indicates that the UE is configured in the base station scheduling-based transmission mode. The base station configures an SL-V-RNTI through RRC signaling, and transmits an uplink grant (UL grant) to the UE through a PDCCH (DCI format 5A, a CRC is scrambled with the SL-V-RNTI). The UL grant includes at least PSSCH time domain and frequency domain resource scheduling information in sidelink communication. When the UE successfully detects the PDCCH scrambled with the SL-V-RNTI, the UE uses PSSCH time domain and frequency domain resource indication fields in the UL grant as PSSCH time domain and frequency domain resource indication information in a PSCCH (SCI format 1), and transmits the PSCCH (SCI format 1) and the corresponding PSSCH.

2) UE sensing-based resource allocation mode (Transmission Mode 4). The UE sensing-based resource allocation mode means that resources used for sidelink communication are based on a procedure of sensing a candidate available resource set by the UE. When the RRC signaling SL-V2X-ConfigDedicated is set to ue-Selected-r14, it indicates that the UE is configured in the UE sensing-based transmission mode. In the UE sensing-based transmission mode, the base station configures an available transmission resource pool, and the UE determines a PSSCH sidelink transmission resource in the transmission resource pool according to a certain rule (for a detailed description of the procedure, see the LTE V2X UE sensing procedure section), and transmits a PSCCH (SCI format 1) and a corresponding PSSCH.

### LTE V2X Resource Allocation Mode: Transmission Mode 4 (Out of eNB Network Coverage)

In case of out of eNB network coverage on a frequency for sidelink communication, LTE V2X only supports the UE sensing-based resource allocation mode, that is, only Transmission Mode 4 is supported. The UE sensing-based resource allocation mode means that resources used for sidelink communication are based on a procedure of sensing a candidate available resource set by the UE. In the UE sensing-based transmission mode, the UE determines a PSSCH sidelink transmission resource in a pre-configured transmission resource pool according to a certain rule (for a detailed description of the procedure, see the LTE V2X UE sensing procedure section), and transmits a PSCCH (SCI format 1) and a corresponding PSSCH.

### NR V2X Resource Allocation Mode 1 and Mode 2

NR V2X (sidelink) sidelink communication includes at least two resource allocation modes, which are respectively referred to as Mode 1, a resource allocation mode based on base station scheduling, and Mode 2, a resource allocation mode of determining sidelink resources by UE. The specific definitions of Mode 1 and Mode 2 are:

1) Mode 1: a base station schedules resources used by UE for sidelink communication; and

2) Mode 2: UE determines, based on sensing, resources used for sidelink communication in resources configured or pre-configured by a base station.

Among them, Mode 2 includes four sub-modes, which are defined as Mode 2(a), Mode 2(b), Mode 2(c), and Mode 2(d), respectively. The specific definitions of the four sub-modes included in Mode 2 are:

1) Mode 2(a): the UE selects resources for sidelink communication by the UE itself;

2) Mode 2(b): the UE assists other UE to select resources for sidelink communication;

3) Mode 2(c): the base station configures a UE NR type 1 configured grant (which may be referred to as CG for short); and

4) Mode 2(d): the UE schedules resources for other UE to perform sidelink communication.

### Method for LTE V2X UE to Determine PSSCH Subframe Resource Pool

In LTE V2X, a method for determining a subframe resource pool is based on all subframes in a range of SFN #0 to SFN #1023, a total of 10240 subframes. Herein, a subframe set that may belong to a PSSCH subframe resource pool transmitted by V2X UE is represented as (t₀^{SL}, t₁^{SL}, . . . t_{T}_{ₘₐₓ}^{SL}), which satisfies:

1) 0≤tᵢ^{SL}<10240;

2) subframes in the above subframe set are numbered relative to subframe #0 of SFN #0 or DFN #0, namely, a subframe with tᵢ^{SL}=0 corresponds to subframe #0 of SFN #0 or DFN #0;

3) the above subframe set includes all subframes after the following subframes (subframes included in a, b, and c) are excluded:
a) subframes configured with an SLSS, the number of which is represented as N_{SLSS};
b) downlink subframes and special subframes in a TDD cell, the number of which is represented as N_{dssf},
c) reserved subframes, where a method for determining the reserved subframes is:
   after N_{SLSS} and N_{dssf} subframes are excluded from all subframes with subframe numbers 0-10239, the remaining (10240−N_{SLSS}−N_{dssf}) subframes are arranged in ascending order of subframe numbers, which can be represented herein as (l₀, l₁, . . . , l_{10240-N}_{_{SLSS}}_{-N}_{_{dssf}}₋₁).

γ=floor(m·(10240−N_{SLSS}−N_{dssf})/N_{reserved}),
where m=0, 1, . . . , N_{reserved}−1, and

N_{reserved}=(10240−N_{SLSS}−N_{dssf})mod L_{bitmap},
L_{bitmap} represents the length of a bitmap configured for the resource pool, and is configured by an upper layer, and the bitmap may be represented as (b₀, b₁, . . . , L_{bimap}), in which a subframe corresponding to the number of Iᵣ is a reserved subframe; and

4) the subframes in the subframe set are arranged in ascending order of subframe numbers.

A method for the UE to determine the PSSCH subframe resource pool is: for subframe tₖ^{SL} in the subframe set (t₀^{SL}, t₁^{SL}, . . . t_{T}_{ₘₐₓ}^{SL}), if b_{k′}=1, where k′=k mod L_{bitmap}, then subframe tₖ^{SL} belongs to the PSSCH subframe resource pool.

### Reserved Resource for LTE V2X Transmission Mode 4 (Transmission Mode 4)

In LTE V2X Transmission Mode 4, when UE determines resources for sidelink communication transmission through a sensing procedure, the UE reserves resources for periodic service data. Assuming that a subframe resource determined by the UE for transmitting a PSSCH is represented as subframe tₘ^{SL}, then the UE reserves the resource in subframe t_{m+j×P}_{^{rsvp_Tx′}}, where j=1, 2, . . . , Cᵣₑₛₑₗ−1, Cᵣₑₛₑₗ=10×SL_RESOURCE_RESELECTION_COUNTER, and SL_RESOURCE_RESELECTION_COUNTER is configured by a higher layer. If the higher layer does not configure the parameter, then Cᵣₑₛₑₗ=1. P_{rsvp_TX′}=Pₛₜₑₚ×P_{rsvp_TX}/100. LTE V2X includes a periodic service, and the period of service generation is approximately Pₛₑᵣᵥ=100 ms, where Pₛₜₑₚ represents the number of uplink subframes available in Pₛₑᵣᵥ. The following table 14.1.1-1 shows the values of Pₛₜₑₚ in different TDD uplink and downlink configuration information in LTE V2X. For example, for TDD UL/DL configuration information 2, each system frame includes two uplink subframes. In a service period of Pₛₑᵣᵥ=100 ms, there are a total of 20 uplink subframes. Table 1 shows determination of Pₛₜₑₚ for edge connection transmission modes 3 and 4, as shown in the following table for details.

TABLE 1
Determination of Pₛₜₑₚ

| | Pₛₜₑₚ |
|---|---|
| TDD UL/DL configuration information 0 | 60 |
| TDD UL/DL configuration information 1 | 40 |
| TDD UL/DL configuration information 2 | 20 |
| TDD UL/DL configuration information 3 | 30 |
| TDD UL/DL configuration information 4 | 20 |
| TDD UL/DL configuration information 5 | 10 |
| TDD UUDL configuration information 6 | 50 |
| Other | 100 |

P_{rsvp_TX} represents a resource reservation interval indicated by an upper layer.

### Determination of Resource Reservation Indication Field in SCI by LTE V2X UE

A resource reservation interval indicated by an upper layer is represented as P_{rsvp_TX}. UE determines the value of X=P_{rsvp_TX}/100 according to the indication of the upper layer, and in conjunction with the following Table 2, the UE can determine a resource reservation indication field (4-bit indication field) in SCI.

TABLE 2

| Resource reservation | | |
|---|---|---|
| indication field in SCI | X | Specific description |
| ′0001′, ′0010′, . . . , ′1010′ | Value of indication | 1 ≤ X ≤ 10 |
| | field in SCI | |
| ′1011′ | 0.5 | X = 0.5 |
| ′1100′ | 0.2 | X = 0.2 |
| ′0000′ | 0 | Upper layer indicates |
| | | no reserved resources |
| ′1101′, ′1110′, ′1111′ | Reserved value | |

### LTE V2X Blind Retransmission

In LTE V2X, at most one blind retransmission is supported. Blind retransmission means that whether a transmitting end performs a retransmission not based on feedback information of a receiving end, but the transmitting end directly transmits the retransmission, or, regardless of whether the receiving end correctly receives an initial transmission of the transmitting end, the transmitting end will directly transmit a retransmission.

In LTE V2X, SCI format 1 transmitted by sidelink communication UE includes an indication of a time domain gap between an initial transmission and a blind retransmission, which is represented by SF_{gap}. If the UE transmits an initial transmission of a certain TB in subframe tₘ^{SL}, then the UE transmits a blind retransmission of the TB in subframe t_{m+SF}_{_{gap}}^{SL}. In both subframe tₘ^{SL} and subframe t_{m+SF}_{_{gap}}^{SL}, the sidelink UE will transmit SCI format 1.

### UE Sensing Procedure in LTE V2X Transmission Mode 4

For a sensing procedure of UE, generally speaking, in LTE V2X Transmission Mode 4, an upper layer requests sidelink data to be transmitted in subframe #n. In subframe t_{n-10×P}_{ₛₜₑₚ}^{SL}, t_{n-10×P}_{ₛₜₑₚ₊₁}^{SL}, . . . , tₙ₋₁^{SL}, the UE monitors SCI format 1 transmitted by other UE, and the UE determines, according to the successfully decoded SCI format 1, an available resource in a candidate resource set between subframe #(n+T1) and subframe #(n+T2), and reports the determined available resource to an upper layer. Among them, if subframe #n belongs to a subframe set (t₀^{SL}, t₁^{SL}, . . . , t_{T}_{ₘₐₓ}^{SL}), otherwise, tₙ^{SL}, indicates the first subframe belonging to the subframe set (t₀^{SL}, t₁^{SL}, . . . , t_{T}_{ₘₐₓ}^{SL}) following subframe #n. T1 and T2 depend on a specific implementation of the UE.

Each element in the candidate resource set between subframe #(n+T1) and subframe #(n+T2), namely, each candidate resource, can be referred to as a candidate single subframe resource, which is represented using R_{x,y}. The specific definition of R_{x,y} is:

1) x represents consecutive L_{subCH} sub-channels #(x+j) in the frequency domain, where j=0, 1, . . . , L_{subCH}−1; and

2) y represents a time domain subframe t_{y}^{SL}.

The UE assumes that between subframe #(n+T1) and subframe #(n+T2), any consecutive L_{subCH} sub-channels belonging to a PSSCH resource pool correspond to one candidate single subframe resource. The candidate resource set is represented using S_{A}.

A resource reservation indication field in the SCI format 1 received by the UE in subframe tₘ^{SL} is denoted as P_{rsvp_RX}. If PSSCH resource blocks and subframe resources indicated in SCI format 1 received by the UE in subframe tₘ^{SL} or the UE assumes that the PSSCH resource blocks and subframe resources indicated in the same SCI format 1 received in subframe t_{m+q×P}_{ₛₜₚ}_{×P}_{_{rsvp_RX}}^{SL} overlap or partially overlap with a candidate single subframe resource R_{x,y+|×P}_{_{rsvp,RX′}}, the UE excludes the candidate single subframe resource R_{x,y} from S_{A}, where q=1, 2, . . . , Q, and j=1, 2, . . . , Cᵣₑₛₑₗ−1. If P_{rsvp_RX}<1 and n′−m≤Pₛₜₑₚ×P_{rsvp_RX}, then Q=1/P_{rsvp_RX}; otherwise, Q=1.

Hereinafter, specific examples and embodiments related to the present invention are described in detail. In addition, as described above, the examples and embodiments described in the present invention are illustrative descriptions for facilitating understanding of the present invention, and are not intended to limit the present invention.

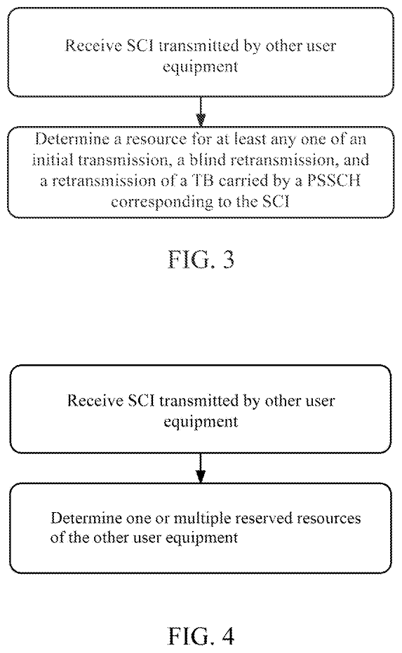

FIG. 3 is a diagram schematically showing a basic procedure of a user equipment method of the present invention, in which the method executed by user equipment (UE) includes a first step and a second step. In the first step, the UE receives SCI transmitted by other UE. In the second step, the UE determines a resource for at least any one of an initial transmission, a blind retransmission, and a retransmission of a transport block (TB) carried by a PSSCH corresponding to the SCI. According to this method, a resource for at least any one of an initial transmission, a blind retransmission, and a retransmission can be determined according to SCI transmitted by other UE, thereby improving the resource utilization efficiency of an entire communication system and reducing the transmission collision probability between user equipment.

FIG. 4 is a diagram schematically showing another basic procedure of a user equipment method of the present invention, in which the method executed by user equipment (UE) includes a first step and a second step. In the first step, the UE receives SCI transmitted by other UE. The SCI includes an indication of a reserved resource interval and/or an indication of a number of reserved resources. In the second step, the UE determines one or multiple reserved resources of the other UE according to the indication of the reserved resource interval and/or the number of reserved resources. According to this method, one or multiple reserved resources of other UE can be determined according to received SCI transmitted by the other UE, thereby improving the resource utilization efficiency of an entire communication system and reducing the transmission collision probability between user equipment.

### Embodiment 1

FIG. 5 is a diagram showing a basic procedure of a method performed by user equipment according to Embodiment 1 of the present invention.

The method performed by user equipment according to Embodiment 1 of the present invention is described in detail below in conjunction with the basic procedure diagram shown in FIG. 5.

As shown in FIG. 5, in Embodiment 1 of the present invention, steps performed by the user equipment include the following steps.

In step S101, the user equipment monitors sidelink control information (SCI) transmitted by other user equipment.

Optionally, the SCI includes indication information indicating that a transport block (TB) carried by a physical sidelink shared channel (PSSCH) corresponding to (or associated with or scheduled by) the SCI is transmitted in an initial transmission.

Optionally, one implementation of the indication information is indication by an indication field in the SCI. For example, 0 indicates an initial transmission and 1 indicates a blind retransmission, or 1 indicates an initial transmission and 0 indicates a blind retransmission. Alternatively, another implementation is that the SCI includes an indication field for indicating the number of transmissions. For example, the number of transmissions being set to 0 indicates an initial transmission, or the number of transmissions being set to 1 indicates an initial transmission. Alternatively, one implementation is implicit indication by a redundancy version (RV) in the SCI. For example, RV=0 indicates an initial transmission, RV=2 indicates the first blind retransmission, RV=3 indicates the second blind retransmission, and RV=1 indicates the third blind retransmission. Alternatively, the SCI includes indication information of the number of remaining blind retransmissions. Implementations of this embodiment include but are not limited to the above implementations.

In step S102, the user equipment determines a resource for the blind retransmission of the TB carried by the PSSCH corresponding to the SCI.

Optionally, the blind retransmission of the TB carried by the PSSCH corresponding to the SCI may be one or more than one blind retransmission, for example, two blind retransmissions, three blind retransmissions, etc., which is not limited in the present invention.

Optionally, the SCI includes a time domain gap between the initial transmission and the blind retransmission. Optionally, the blind retransmission is the first blind retransmission.

Optionally, the user equipment determines that the index of the first blind retransmission is (initial transmission index+gap), the index of the second blind retransmission is (initial transmission index+2*gap), and so on.

Alternatively, optionally, the user equipment determines that the index of the remaining first blind retransmission is (initial transmission index+gap), the index of the remaining second blind retransmission is (initial transmission index+2*gap), and so on.

In step S103, the user equipment excludes, from a candidate resource set or a resource set, a resource that overlaps with the resource for the one or plurality of blind retransmissions determined by the user equipment. Overlapping means that time domain and frequency domain resources partially overlap or completely overlap. The user equipment selects a sidelink communication transmission resource from the unexcluded candidate resource set or resource set.

Optionally, a condition for the user equipment to exclude, from the candidate resource set or resource set, the resource that overlaps with the resource for the one or plurality of blind retransmissions determined by the user equipment includes, but is not limited to, the following condition: overlapping with the resource for the one or plurality of blind retransmissions. That is to say, the condition for the user equipment to exclude one or some resources from the candidate resource set or resource set may also include other conditions at the same time (satisfying the other conditions at the same time, for example, RSRP corresponding to the PSSCH corresponding to the SCI is greater than a configured or pre-configured threshold, etc.).

### Embodiment 2

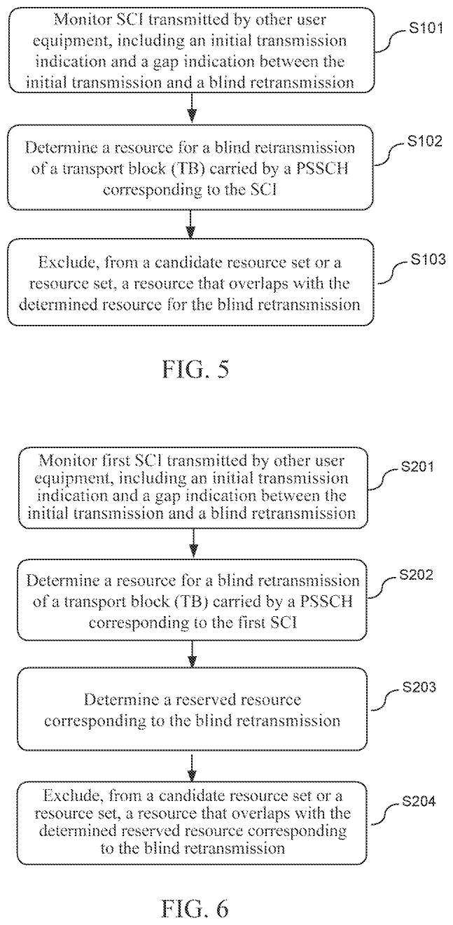

FIG. 6 is a diagram showing a basic procedure of a method performed by user equipment according to Embodiment 2 of the present invention.

The method performed by user equipment according to Embodiment 2 of the present invention is described in detail below in conjunction with the basic procedure diagram shown in FIG. 6.

As shown in FIG. 6, in Embodiment 2 of the present invention, steps performed by the user equipment include the following steps.

In step S201, the user equipment monitors first sidelink control information (SCI) transmitted by other user equipment.

Optionally, the first SCI includes indication information indicating that a transport block (TB) carried by a physical sidelink shared channel (PSSCH) corresponding to (or associated with or scheduled by) the first SCI is transmitted in an initial transmission.

Optionally, one implementation of the indication information is indication by an indication field in the first SCI. For example, 0 indicates an initial transmission and 1 indicates a blind retransmission, or 1 indicates an initial transmission and 0 indicates a blind retransmission. Alternatively, another implementation is that the first SCI includes an indication field for indicating the number of transmissions. For example, the number of transmissions being set to 0 indicates an initial transmission, or the number of transmissions being set to 1 indicates an initial transmission. Alternatively, one implementation is implicit indication by a redundancy version (RV) in the first SCI. For example, RV=0 indicates an initial transmission, RV=2 indicates the first blind retransmission, RV=3 indicates the second blind retransmission, and RV=1 indicates the third blind retransmission. Alternatively, the first SCI includes indication information of the number of remaining blind retransmissions. Implementations of this embodiment include but are not limited to the above implementations.

In step S202, the user equipment determines a resource for the blind retransmission of the TB carried by the PSSCH corresponding to the first SCI.

Optionally, the blind retransmission of the TB carried by the PSSCH corresponding to the first SCI may be one or more than one blind retransmission, for example, two blind retransmissions, three blind retransmissions, etc., which is not limited in the present invention.

Optionally, the first SCI includes a time domain gap between the initial transmission and the blind retransmission. Optionally, the blind retransmission is the first blind retransmission.

Optionally, the user equipment determines that the index of the first blind retransmission is (initial transmission index+gap), the index of the second blind retransmission is (initial transmission index+2*gap), and so on.

Alternatively, optionally, the user equipment determines that the index of the remaining first blind retransmission is (initial transmission index+gap), the index of the remaining second blind retransmission is (initial transmission index+2*gap), and so on.

In step S203, the user equipment determines a reserved resource corresponding to the one or plurality of blind retransmissions.

Optionally, the reserved resource corresponding to the one or plurality of blind retransmissions is indicated by second SCI corresponding to the blind retransmission.

Optionally, the second SCI includes an indication of a reserved resource interval (reservation interval).

Optionally, the user equipment determines that the index of a reserved resource corresponding to the first blind retransmission is (first blind retransmission index+reservation interval*time granularity). Optionally, the time granularity is 100 or 10, which is not limited in the present invention. The index of a reserved resource corresponding to the second blind retransmission is (second blind retransmission index+reservation interval*time granularity), and so on. Alternatively, optionally, the user equipment determines that the index of a reserved resource corresponding to the remaining first blind retransmission is (remaining first blind retransmission index+reservation interval*time granularity). Optionally, the time granularity is 100 or 10, which is not limited in the present invention. The index of a reserved resource corresponding to the remaining second blind retransmission is (remaining second blind retransmission index+reservation interval*time granularity), and so on.

Alternatively,

optionally, the user equipment determines, according to the first SCI, the reserved resource corresponding to the one or plurality of blind retransmissions.

Optionally, the first SCI includes the indication of the reserved resource interval (reservation interval).

Optionally, the user equipment determines that the index of the reserved resource corresponding to the first blind retransmission is (initial transmission index+gap+reservation interval*time granularity). Optionally, the time granularity is 100 or 10, which is not limited in the present invention. The index of the reserved resource corresponding to the second blind retransmission is (initial transmission index+2*gap+reservation interval*time granularity), and so on. Alternatively, the user equipment determines that the index of the reserved resource corresponding to the remaining first blind retransmission is (initial transmission index+gap+reservation interval*time granularity). Optionally, the time granularity is 100 or 10, which is not limited in the present invention. The index of the reserved resource corresponding to the remaining second blind retransmission is (initial transmission index+2*gap+reservation interval*time granularity), and so on.

Optionally, the reserved resource corresponding to the one or plurality of blind retransmissions is a resource of other TBs different from the TB. The resource of the other TBs may be a blind retransmission resource, or may be an initial transmission resource, which is not limited in the present invention.

In step S204, the user equipment excludes, from a candidate resource set or a resource set, a resource that overlaps with the reserved resource corresponding to the one or plurality of blind retransmissions determined by the user equipment. Overlapping means that time domain and frequency domain resources partially overlap or completely overlap. The user equipment selects a sidelink communication transmission resource from the unexcluded candidate resource set or resource set.

Optionally, a condition for the user equipment to exclude, from the candidate resource set or resource set, the resource that overlaps with the reserved resource corresponding to the one or plurality of blind retransmissions determined by the user equipment includes, but is not limited to, the following condition: overlapping with the reserved resource corresponding to the one or plurality of blind retransmissions. That is to say, the condition for the user equipment to exclude one or some resources from the candidate resource set or resource set may also include other conditions at the same time (satisfying the other conditions at the same time, for example, RSRP corresponding to the PSSCH corresponding to the first SCI is greater than a configured or pre-configured threshold, etc.).

### Embodiment 3

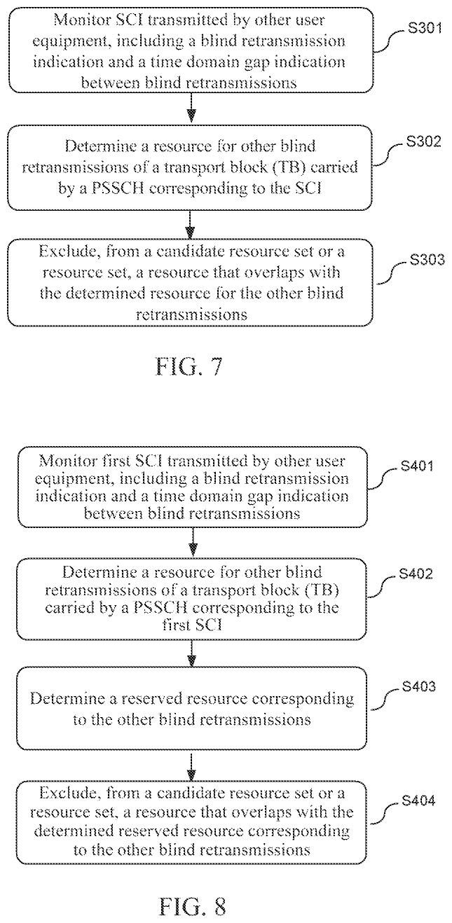

FIG. 7 is a diagram showing a basic procedure of a method performed by user equipment according to Embodiment 3 of the present invention.

The method performed by user equipment according to Embodiment 3 of the present invention is described in detail below in conjunction with the basic procedure diagram shown in FIG. 7.

As shown in FIG. 7, in Embodiment 3 of the present invention, steps performed by the user equipment include the following steps.

In step S301, the user equipment monitors sidelink control information (SCI) transmitted by other user equipment.

Optionally, the SCI includes indication information indicating that a transport block (TB) carried by a physical sidelink shared channel (PSSCH) corresponding to (or associated with or scheduled by) the SCI is transmitted in a blind retransmission.

Optionally, one implementation of the indication information is indication by an indication field in the SCI. For example, 0 indicates an initial transmission and 1 indicates a blind retransmission, or 1 indicates an initial transmission and 0 indicates a blind retransmission. Alternatively, another implementation is that the SCI includes an indication field for indicating the number of transmissions. For example, the number of transmissions being set to 1 indicates the first blind retransmission and 2 indicates the second blind retransmission, or the number of transmissions being set to 2 indicates the first blind retransmission and 3 indicates the second blind retransmission. Alternatively, one implementation is implicit indication by a redundancy version (RV) in the SCI. For example, RV=0 indicates an initial transmission, RV=2 indicates the first blind retransmission, RV=3 indicates the second blind retransmission, and RV=1 indicates the third blind retransmission. Alternatively, the SCI includes indication information of the number of remaining blind retransmissions. Implementations of this embodiment include but are not limited to the above implementations.

In step S302, the user equipment determines a resource for other blind retransmissions of the TB carried by the PSSCH corresponding to the SCI.

Optionally, the other blind retransmissions refer to zero or one or multiple blind retransmissions of the TB that occurs after the blind retransmission in the time domain.

Optionally, the SCI includes a time domain gap between blind retransmissions.

Optionally, the blind retransmission is the first blind retransmission.

Optionally, the user equipment determines that the index of the second blind retransmission is (first blind retransmission index+gap), the index of the third blind retransmission is (first blind retransmission index+2*gap), and so on. Alternatively, the blind retransmission is the k^{th} blind retransmission, and the index of the (k+1)^{th} blind retransmission is (k^{th} blind retransmission index+gap), the index of the (k+2)^{th} blind retransmission is (k^{th} blind retransmission index+2*gap), the index of the (k−1)^{th} blind retransmission is (k^{th} blind retransmission index−gap), and so on.

Alternatively, optionally, the other blind retransmissions refer to remaining blind retransmissions indicated in the SCI.

Optionally, the user equipment determines that the index of the remaining first blind retransmission is (blind retransmission index+gap), the index of the remaining second blind retransmission is (blind retransmission index+2*gap), and so on.

In step S303, the user equipment excludes, from a candidate resource set or a resource set, a resource that overlaps with the resource for the other blind retransmissions determined by the user equipment. Overlapping means that time domain and frequency domain resources partially overlap or completely overlap. The user equipment selects a sidelink communication transmission resource from the unexcluded candidate resource set or resource set.

Optionally, a condition for the user equipment to exclude, from the candidate resource set or resource set, the resource that overlaps with the resource for the other blind retransmissions determined by the user equipment includes, but is not limited to, the following condition: overlapping with the resource for the other blind retransmissions. That is to say, the condition for the user equipment to exclude one or some resources from the candidate resource set or resource set may also include other conditions at the same time (satisfying the other conditions at the same time, for example, RSRP corresponding to the PSSCH corresponding to the SCI is greater than a configured or pre-configured threshold, etc.).

### Embodiment 4

FIG. 8 is a diagram showing a basic procedure of a method performed by user equipment according to Embodiment 4 of the present invention.

The method performed by user equipment according to Embodiment 4 of the present invention is described in detail below in conjunction with the basic procedure diagram shown in FIG. 8.

As shown in FIG. 8, in Embodiment 4 of the present invention, steps performed by the user equipment include the following steps.

In step S401, the user equipment monitors first sidelink control information (SCI) transmitted by other user equipment.

Optionally, the first SCI includes indication information indicating that a transport block (TB) carried by a physical sidelink shared channel (PSSCH) corresponding to (or associated with or scheduled by) the first SCI is transmitted in a blind retransmission.

Optionally, one implementation of the indication information is indication by an indication field in the first SCI. For example, 0 indicates an initial transmission and 1 indicates a blind retransmission, or 1 indicates an initial transmission and 0 indicates a blind retransmission. Alternatively, another implementation is that the first SCI includes an indication field for indicating the number of transmissions. For example, the number of transmissions being set to 1 indicates the first blind retransmission and 2 indicates the second blind retransmission, or the number of transmissions being set to 2 indicates the first blind retransmission and 3 indicates the second blind retransmission. Alternatively, one implementation is implicit indication by a redundancy version (RV) in the first SCI. For example, RV=0 indicates an initial transmission, RV=2 indicates the first blind retransmission, RV=3 indicates the second blind retransmission, and RV=1 indicates the third blind retransmission. Alternatively, the first SCI includes indication information of the number of remaining blind retransmissions. Implementations of this embodiment include but are not limited to the above implementations.

In step S402, the user equipment determines a resource for other blind retransmissions of the TB carried by the PSSCH corresponding to the first SCI.

Optionally, the other blind retransmissions refer to zero or one or multiple other blind retransmissions of the TB.

Optionally, the first SCI includes a time domain gap between blind retransmissions.

Optionally, the blind retransmission is the first blind retransmission.

Optionally, the user equipment determines that the index of the second blind retransmission is (first blind retransmission index+gap), the index of the third blind retransmission is (first blind retransmission index+2*gap), and so on. Alternatively, the blind retransmission is the k^{th} blind retransmission, and the index of the (k+1)^{th} blind retransmission is (k^{th} blind retransmission index+gap), the index of the (k+2)^{th} blind retransmission is (k^{th} blind retransmission index+2*gap), the index of the (k−1)^{th} blind retransmission is (k^{th} blind retransmission index−gap), and so on.

Optionally, the user equipment determines that the index of the remaining first blind retransmission is (blind retransmission index+gap), the index of the remaining second blind retransmission is (blind retransmission index+2*gap), and so on.

Optionally, the user equipment determines a resource for or an index of the one or plurality of blind retransmissions located before the blind retransmission in the time domain.

In step S403, the user equipment determines a reserved resource corresponding to the other blind retransmissions.

Optionally, the reserved resource corresponding to the other blind retransmissions is indicated by second SCI corresponding to the other blind retransmissions.

Optionally, the second SCI includes an indication of a reserved resource interval (reservation interval).

Optionally, the user equipment determines that the index of a reserved resource corresponding to the first blind retransmission is (first blind retransmission index+reservation interval*time granularity). Optionally, the time granularity is 100 or 10, which is not limited in the present invention. The index of a reserved resource corresponding to the second blind retransmission is (second blind retransmission index+reservation interval*time granularity), and so on.

Alternatively,

optionally, the user equipment determines, according to the first SCI, the reserved resource corresponding to the other blind retransmissions.

Optionally, the user equipment determines, according to the first SCI, the reserved resource corresponding to the remaining blind retransmission, and/or the reserved resource corresponding to the one or plurality of blind retransmissions located before the blind retransmission in the time domain.

Optionally, the first SCI includes the indication of the reserved resource interval (reservation interval).

Optionally, the first SCI corresponds to the k^{th} blind retransmission, and the index of a reserved resource corresponding to the k^{th} blind retransmission is (k^{th} blind retransmission index+reservation interval*time granularity), the index of a reserved resource corresponding to the (k+1)^{th} blind retransmission is (k^{th} blind retransmission index+gap+reservation interval*time granularity), the index of a reserved resource corresponding to the (k−1)^{th} blind retransmission is (k^{th} blind retransmission index−gap+reservation interval*time granularity), and so on. Optionally, the time granularity is 100 or 10, which is not limited in the present invention.

Optionally, the reserved resource corresponding to the other blind retransmissions is a resource of other TBs different from the TB. The resource of the other TBs may be a blind retransmission resource, or may be an initial transmission resource, which is not limited in the present invention.

In step S404, the user equipment excludes, from a candidate resource set or a resource set, a resource that overlaps with the reserved resource corresponding to the other blind retransmissions determined by the user equipment. Overlapping means that time domain and frequency domain resources partially overlap or completely overlap. The user equipment selects a sidelink communication transmission resource from the unexcluded candidate resource set or resource set.

Optionally, a condition for the user equipment to exclude, from the candidate resource set or resource set, the resource that overlaps with the reserved resource corresponding to the other blind retransmissions determined by the user equipment includes, but is not limited to, the following condition: overlapping with the reserved resource corresponding to the other blind retransmissions. That is to say, the condition for the user equipment to exclude one or some resources from the candidate resource set or resource set may also include other conditions at the same time (satisfying the other conditions at the same time, for example, RSRP corresponding to the PSSCH corresponding to the first SCI is greater than a configured or pre-configured threshold, etc.).

### Embodiment 5

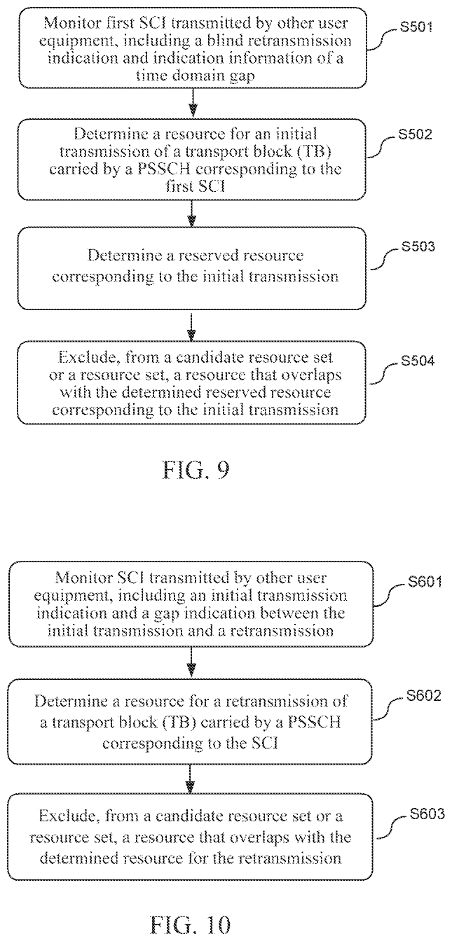

FIG. 9 is a diagram showing a basic procedure of a method performed by user equipment according to Embodiment 5 of the present invention.

The method performed by user equipment according to Embodiment 5 of the present invention is described in detail below in conjunction with the basic procedure diagram shown in FIG. 9.

As shown in FIG. 9, in Embodiment 5 of the present invention, steps performed by the user equipment include the following steps.

In step S501, the user equipment monitors first sidelink control information (SCI) transmitted by other user equipment.

Optionally, the first SCI includes indication information indicating that a transport block (TB) carried by a physical sidelink shared channel (PSSCH) corresponding to (or associated with or scheduled by) the first SCI is transmitted in a blind retransmission.

Optionally, one implementation of the indication information is indication by an indication field in the first SCI. For example, 0 indicates an initial transmission and 1 indicates a blind retransmission, or 1 indicates an initial transmission and 0 indicates a blind retransmission. Alternatively, another implementation is that the first SCI includes an indication field for indicating the number of transmissions. For example, the number of transmissions being set to 1 indicates the first blind retransmission and 2 indicates the second blind retransmission, or the number of transmissions being set to 2 indicates the first blind retransmission and 3 indicates the second blind retransmission. Alternatively, one implementation is implicit indication by a redundancy version (RV) in the first SCI. For example, RV=0 indicates an initial transmission, RV=2 indicates the first blind retransmission, RV=3 indicates the second blind retransmission, and RV=1 indicates the third blind retransmission. Implementations of this embodiment include but are not limited to the above implementations.

In step S502, the user equipment determines a resource for the initial transmission of the TB carried by the PSSCH corresponding to the first SCI.

Optionally, the first SCI includes indication information gap of a time domain gap.

Optionally, the blind retransmission is the k^{th} blind retransmission, and the index of the initial transmission is (k^{th} blind retransmission index−gap*k).

In step S503, the user equipment determines a reserved resource corresponding to the initial transmission.

Optionally, the reserved resource corresponding to the initial transmission is indicated by second SCI corresponding to the initial transmission.

Optionally, the second SCI includes an indication of a reserved resource interval (reservation interval).

Optionally, the user equipment determines that the index of the reserved resource corresponding to the initial transmission is (initial transmission index+reservation interval*time granularity). Optionally, the time granularity is 100 or 10, which is not limited in the present invention.

Alternatively,

optionally, the user equipment determines, according to the first SCI, the reserved resource corresponding to the initial transmission.

Optionally, the first SCI includes the indication of the reserved resource interval (reservation interval).

Optionally, the first SCI corresponds to the k^{th} blind retransmission, and the index of the reserved resource corresponding to the initial transmission is (k^{th} blind retransmission index−k*gap+reservation interval*time granularity). Optionally, the time granularity is 100 or 10, which is not limited in the present invention.

In step S504, the user equipment excludes, from a candidate resource set or a resource set, a resource that overlaps with the reserved resource corresponding to the initial transmission determined by the user equipment. Overlapping means that time domain and frequency domain resources partially overlap or completely overlap. The user equipment selects a sidelink communication transmission resource from the unexcluded candidate resource set or resource set.

Optionally, a condition for the user equipment to exclude, from the candidate resource set or resource set, the resource that overlaps with the reserved resource corresponding to the initial transmission determined by the user equipment includes, but is not limited to, the following condition: overlapping with the reserved resource corresponding to the initial transmission. That is to say, the condition for the user equipment to exclude one or some resources from the candidate resource set or resource set may also include other conditions at the same time (satisfying the other conditions at the same time, for example, RSRP corresponding to the PSSCH corresponding to the first SCI is greater than a configured or pre-configured threshold, etc.).

### Embodiment 6

FIG. 10 is a diagram showing a basic procedure of a method performed by user equipment according to Embodiment 6 of the present invention.

The method performed by user equipment according to Embodiment 6 of the present invention is described in detail below in conjunction with the basic procedure diagram shown in FIG. 10.

As shown in FIG. 10, in Embodiment 6 of the present invention, steps performed by the user equipment include the following steps.

In step S601, the user equipment monitors sidelink control information (SCI) transmitted by other user equipment.

Optionally, the SCI includes indication information indicating that a transport block (TB) carried by a physical sidelink shared channel (PSSCH) corresponding to (or associated with or scheduled by) the SCI is transmitted in an initial transmission.

Optionally, one implementation of the indication information is indication by an indication field in the SCI. For example, 0 indicates an initial transmission and 1 indicates a retransmission, or 1 indicates an initial transmission and 0 indicates a retransmission. Alternatively, another implementation is that the SCI includes an indication field for indicating the number of transmissions. For example, the number of transmissions being set to 0 indicates an initial transmission, or the number of transmissions being set to 1 indicates an initial transmission. Alternatively, one implementation is implicit indication by a redundancy version (RV) in the SCI. For example, RV=0 indicates an initial transmission, RV=2 indicates the first retransmission, RV=3 indicates the second retransmission, and RV=1 indicates the third retransmission. Alternatively, the SCI includes indication information of the number of remaining retransmissions.

Implementations of this embodiment include but are not limited to the above implementations.

In step S602, the user equipment determines a resource for the retransmission of the TB carried by the PSSCH corresponding to the SCI.

Optionally, the retransmission of the TB carried by the PSSCH corresponding to the SCI may be one or more than one retransmission, for example, two retransmissions, three retransmissions, etc., which is not limited in the present invention.

Optionally, the SCI includes a time domain gap between the initial transmission and the retransmission. Optionally, the retransmission is the first retransmission.

Optionally, the user equipment determines that the index of the first retransmission is (initial transmission index+gap), the index of the second retransmission is (initial transmission index+2*gap), and so on.

Alternatively, optionally, the user equipment determines that the index of the remaining first retransmission is (initial transmission index+gap), the index of the remaining second retransmission is (initial transmission index+2*gap), and so on.

In step S603, the user equipment excludes, from a candidate resource set or a resource set, a resource that overlaps with the resource for the one or plurality of retransmissions determined by the user equipment. Overlapping means that time domain and frequency domain resources partially overlap or completely overlap. The user equipment selects a sidelink communication transmission resource from the unexcluded candidate resource set or resource set.

Optionally, a condition for the user equipment to exclude, from the candidate resource set or resource set, the resource that overlaps with the resource for the one or plurality of retransmissions determined by the user equipment includes, but is not limited to, the following condition: overlapping with the resource for the one or plurality of retransmissions. That is to say, the condition for the user equipment to exclude one or some resources from the candidate resource set or resource set may also include other conditions at the same time (satisfying the other conditions at the same time, for example, RSRP corresponding to the PSSCH corresponding to the SCI is greater than a configured or pre-configured threshold, etc.).

### Embodiment 7

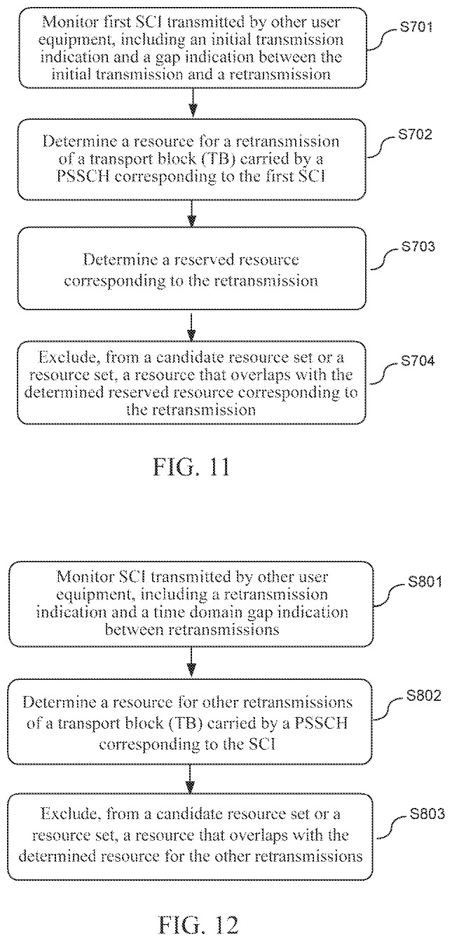

FIG. 11 is a diagram showing a basic procedure of a method performed by user equipment according to Embodiment 7 of the present invention.

The method performed by user equipment according to Embodiment 7 of the present invention is described in detail below in conjunction with the basic procedure diagram shown in FIG. 11.

As shown in FIG. 11, in Embodiment 7 of the present invention, steps performed by the user equipment include the following steps.

In step S701, the user equipment monitors first sidelink control information (SCI) transmitted by other user equipment.

Optionally, the first SCI includes indication information indicating that a transport block (TB) carried by a physical sidelink shared channel (PSSCH) corresponding to (or associated with or scheduled by) the first SCI is transmitted in an initial transmission.

Optionally, one implementation of the indication information is indication by an indication field in the first SCI. For example, 0 indicates an initial transmission and 1 indicates a retransmission, or 1 indicates an initial transmission and 0 indicates a retransmission. Alternatively, another implementation is that the first SCI includes an indication field for indicating the number of transmissions. For example, the number of transmissions being set to 0 indicates an initial transmission, or the number of transmissions being set to 1 indicates an initial transmission. Alternatively, one implementation is implicit indication by a redundancy version (RV) in the first SCI. For example, RV=0 indicates an initial transmission, RV=2 indicates the first retransmission, RV=3 indicates the second retransmission, and RV=1 indicates the third retransmission. Alternatively, the first SCI includes indication information of the number of remaining retransmissions. Implementations of this embodiment include but are not limited to the above implementations.

In step S702, the user equipment determines a resource for the retransmission of the TB carried by the PSSCH corresponding to the first SCI.

Optionally, the retransmission of the TB carried by the PSSCH corresponding to the first SCI may be one or more than one retransmission, for example, two retransmissions, three retransmissions, etc., which is not limited in the present invention.

Optionally, the first SCI includes a time domain gap between the initial transmission and the retransmission. Optionally, the retransmission is the first retransmission.

Optionally, the user equipment determines that the index of the first retransmission is (initial transmission index+gap), the index of the second retransmission is (initial transmission index+2*gap), and so on.

Alternatively, optionally, the user equipment determines that the index of the remaining first retransmission is (initial transmission index+gap), the index of the remaining second retransmission is (initial transmission index+2*gap), and so on.

In step S703, the user equipment determines a reserved resource corresponding to the one or plurality of retransmissions.

Optionally, the reserved resource corresponding to the one or plurality of retransmissions is indicated by second SCI corresponding to the retransmission.

Optionally, the second SCI includes an indication of a reserved resource interval (reservation interval).

Optionally, the user equipment determines that the index of a reserved resource corresponding to the first retransmission is (first retransmission index+reservation interval*time granularity). Optionally, the time granularity is 100 or 10, which is not limited in the present invention. The index of a reserved resource corresponding to the second retransmission is (second retransmission index+reservation interval*time granularity), and so on. Alternatively, optionally, the user equipment determines that the index of a reserved resource corresponding to the remaining first retransmission is (remaining first retransmission index+reservation interval*time granularity). Optionally, the time granularity is 100 or 10, which is not limited in the present invention. The index of a reserved resource corresponding to the remaining second retransmission is (remaining second retransmission index+reservation interval*time granularity), and so on.

Alternatively,

optionally, the user equipment determines, according to the first SCI, the reserved resource corresponding to the one or plurality of retransmissions.

Optionally, the first SCI includes the indication of the reserved resource interval (reservation interval).

Optionally, the user equipment determines that the index of the reserved resource corresponding to the first retransmission is (initial transmission index+gap+reservation interval*time granularity). Optionally, the time granularity is 100 or 10, which is not limited in the present invention. The index of the reserved resource corresponding to the second retransmission is (initial transmission index+2*gap+reservation interval*time granularity), and so on. Alternatively, the user equipment determines that the index of the reserved resource corresponding to the remaining first retransmission is (initial transmission index+gap+reservation interval*time granularity). Optionally, the time granularity is 100 or 10, which is not limited in the present invention. The index of the reserved resource corresponding to the remaining second retransmission is (initial transmission index+2*gap+reservation interval*time granularity), and so on.

Optionally, the reserved resource corresponding to the one or plurality of retransmissions is a resource of other TBs different from the TB. The resource of the other TBs may be a retransmission resource, or may be an initial transmission resource, which is not limited in the present invention.

In step S704, the user equipment excludes, from a candidate resource set or a resource set, a resource that overlaps with the reserved resource corresponding to the one or plurality of retransmissions determined by the user equipment. Overlapping means that time domain and frequency domain resources partially overlap or completely overlap. The user equipment selects a sidelink communication transmission resource from the unexcluded candidate resource set or resource set.

Optionally, a condition for the user equipment to exclude, from the candidate resource set or resource set, the resource that overlaps with the reserved resource corresponding to the one or plurality of retransmissions determined by the user equipment includes, but is not limited to, the following condition: overlapping with the reserved resource corresponding to the one or plurality of retransmissions. That is to say, the condition for the user equipment to exclude one or some resources from the candidate resource set or resource set may also include other conditions at the same time (satisfying the other conditions at the same time, for example, RSRP corresponding to the PSSCH corresponding to the first SCI is greater than a configured or pre-configured threshold, etc.).

### Embodiment 8

FIG. 12 is a diagram showing a basic procedure of a method performed by user equipment according to Embodiment 8 of the present invention.

The method performed by user equipment according to Embodiment 8 of the present invention is described in detail below in conjunction with the basic procedure diagram shown in FIG. 12.

As shown in FIG. 12, in Embodiment 8 of the present invention, steps performed by the user equipment include the following steps.

In step S801, the user equipment monitors sidelink control information (SCI) transmitted by other user equipment.

Optionally, the SCI includes indication information indicating that a transport block (TB) carried by a physical sidelink shared channel (PSSCH) corresponding to (or associated with or scheduled by) the SCI is transmitted in a retransmission.

Optionally, one implementation of the indication information is indication by an indication field in the SCI. For example, 0 indicates an initial transmission and 1 indicates a retransmission, or 1 indicates an initial transmission and 0 indicates a retransmission.

Alternatively, another implementation is that the SCI includes an indication field for indicating the number of transmissions. For example, the number of transmissions being set to 1 indicates the first retransmission and 2 indicates the second retransmission, or the number of transmissions being set to 2 indicates the first retransmission and 3 indicates the second retransmission. Alternatively, one implementation is implicit indication by a redundancy version (RV) in the SCI. For example, RV=0 indicates an initial transmission, RV=2 indicates the first retransmission, RV=3 indicates the second retransmission, and RV=1 indicates the third retransmission. Alternatively, the SCI includes indication information of the number of remaining retransmissions. Implementations of this embodiment include but are not limited to the above implementations.

In step S802, the user equipment determines a resource for other retransmissions of the TB carried by the PSSCH corresponding to the SCI.

Optionally, the other retransmissions refer to zero or one or multiple retransmissions of the TB that occurs after the retransmission in the time domain.

Optionally, the SCI includes a time domain gap between retransmissions.

Optionally, the retransmission is the first retransmission.

Optionally, the user equipment determines that the index of the second retransmission is (first retransmission index+gap), the index of the third retransmission is (first retransmission index+2*gap), and so on. Alternatively, the retransmission is the k^{th} retransmission, and the index of the (k+1)^{th} retransmission is (k^{th} retransmission index+gap), the index of the (k+2)^{th} retransmission is (k^{th} retransmission index+2*gap), the index of the (k−1)^{th} retransmission is (k^{th} retransmission index−gap), and so on.

Alternatively, optionally, the other retransmissions refer to remaining retransmissions indicated in the SCI.

Optionally, the user equipment determines that the index of the remaining first retransmission is (retransmission index+gap), the index of the remaining second retransmission is (retransmission index+2*gap), and so on.

In step S803, the user equipment excludes, from a candidate resource set or a resource set, a resource that overlaps with the resource for the other retransmissions determined by the user equipment. Overlapping means that time domain and frequency domain resources partially overlap or completely overlap. The user equipment selects a sidelink communication transmission resource from the unexcluded candidate resource set or resource set.

Optionally, a condition for the user equipment to exclude, from the candidate resource set or resource set, the resource that overlaps with the resource for the other retransmissions determined by the user equipment includes, but is not limited to, the following condition: overlapping with the resource for the other retransmissions. That is to say, the condition for the user equipment to exclude one or some resources from the candidate resource set or resource set may also include other conditions at the same time (satisfying the other conditions at the same time, for example, RSRP corresponding to the PSSCH corresponding to the SCI is greater than a configured or pre-configured threshold, etc.).

### Embodiment 9

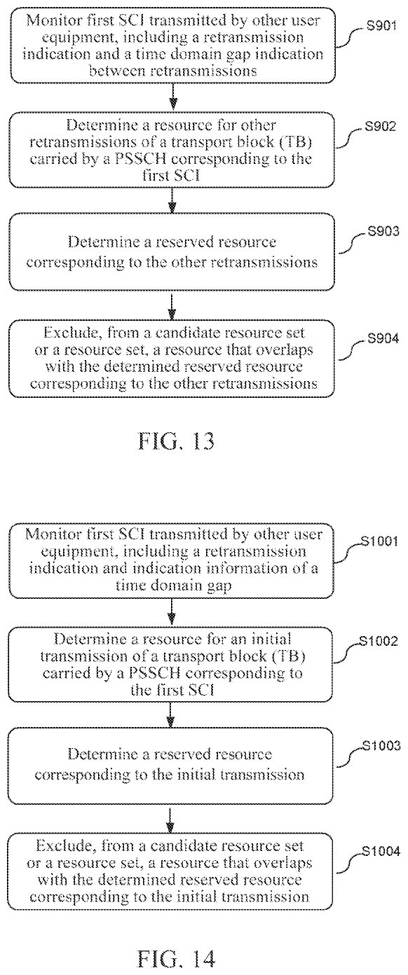

FIG. 13 is a diagram showing a basic procedure of a method performed by user equipment according to Embodiment 9 of the present invention.

The method performed by user equipment according to Embodiment 9 of the present invention is described in detail below in conjunction with the basic procedure diagram shown in FIG. 13.

As shown in FIG. 13, in Embodiment 9 of the present invention, steps performed by the user equipment include the following steps.

In step S901, the user equipment monitors first sidelink control information (SCI) transmitted by other user equipment.

Optionally, the first SCI includes indication information indicating that a transport block (TB) carried by a physical sidelink shared channel (PSSCH) corresponding to (or associated with or scheduled by) the first SCI is transmitted in a retransmission.

Optionally, one implementation of the indication information is indication by an indication field in the first SCI. For example, 0 indicates an initial transmission and 1 indicates a retransmission, or 1 indicates an initial transmission and 0 indicates a retransmission. Alternatively, another implementation is that the first SCI includes an indication field for indicating the number of transmissions. For example, the number of transmissions being set to 1 indicates the first retransmission and 2 indicates the second retransmission, or the number of transmissions being set to 2 indicates the first retransmission and 3 indicates the second retransmission. Alternatively, one implementation is implicit indication by a redundancy version (RV) in the first SCI. For example, RV=0 indicates an initial transmission, RV=2 indicates the first retransmission, RV=3 indicates the second retransmission, and RV=1 indicates the third retransmission. Alternatively, the first SCI includes indication information of the number of remaining retransmissions. Implementations of this embodiment include but are not limited to the above implementations.

In step S902, the user equipment determines a resource for other retransmissions of the TB carried by the PSSCH corresponding to the first SCI.

Optionally, the other retransmissions refer to zero or one or multiple other retransmissions of the TB.

Optionally, the first SCI includes a time domain gap between retransmissions. Optionally, the retransmission is the first retransmission.

Optionally, the user equipment determines that the index of the second retransmission is (first retransmission index+gap), the index of the third retransmission is (first retransmission index+2*gap), and so on. Alternatively, the retransmission is the k^{th} retransmission, and the index of the (k+1)^{th} retransmission is (k^{th} retransmission index+gap), the index of the (k+2)^{th} retransmission is (k^{th} retransmission index+2*gap), the index of the (k−1)^{th} retransmission is (k^{th} retransmission index−gap), and so on. Alternatively, optionally, the user equipment determines that the index of the remaining first retransmission is (retransmission index+gap), the index of the remaining second retransmission is (retransmission index+2*gap), and so on.

Optionally, the user equipment determines a resource for or an index of the one or plurality of retransmissions located before the retransmission in the time domain.

In step S903, the user equipment determines a reserved resource corresponding to the other retransmissions.

Optionally, the reserved resource corresponding to the other retransmissions is indicated by second SCI corresponding to the other retransmissions.

Optionally, the second SCI includes an indication of a reserved resource interval (reservation interval).

Optionally, the user equipment determines that the index of a reserved resource corresponding to the first retransmission is (first retransmission index+reservation interval*time granularity). Optionally, the time granularity is 100 or 10, which is not limited in the present invention. The index of a reserved resource corresponding to the second retransmission is (second retransmission index+reservation interval*time granularity), and so on.

Alternatively,

optionally, the user equipment determines, according to the first SCI, the reserved resource corresponding to the other retransmissions.

Optionally, the user equipment determines, according to the first SCI, the reserved resource corresponding to the remaining retransmission, and/or the reserved resource corresponding to the one or plurality of retransmissions located before the retransmission in the time domain.

Optionally, the first SCI includes the indication of the reserved resource interval (reservation interval).

Optionally, the first SCI corresponds to the k^{th} retransmission, and the index of a reserved resource corresponding to the k^{th} retransmission is (k^{th} retransmission index+reservation interval*time granularity), the index of a reserved resource corresponding to the (k+1)^{th} retransmission is (k^{th} retransmission index+gap+reservation interval*time granularity), the index of a reserved resource corresponding to the (k−1)^{th} retransmission is (k^{th} retransmission index−gap+reservation interval*time granularity), and so on. Optionally, the time granularity is 100 or 10, which is not limited in the present invention.

Optionally, the reserved resource corresponding to the other retransmissions is a resource of other TBs different from the TB. The resource of the other TBs may be a retransmission resource, or may be an initial transmission resource, which is not limited in the present invention.

In step S904, the user equipment excludes, from a candidate resource set or a resource set, a resource that overlaps with the reserved resource corresponding to the other retransmissions determined by the user equipment. Overlapping means that time domain and frequency domain resources partially overlap or completely overlap. The user equipment selects a sidelink communication transmission resource from the unexcluded candidate resource set or resource set.

Optionally, a condition for the user equipment to exclude, from the candidate resource set or resource set, the resource that overlaps with the reserved resource corresponding to the other retransmissions determined by the user equipment includes, but is not limited to, the following condition: overlapping with the reserved resource corresponding to the other retransmissions. That is to say, the condition for the user equipment to exclude one or some resources from the candidate resource set or resource set may also include other conditions at the same time (satisfying the other conditions at the same time, for example, RSRP corresponding to the PSSCH corresponding to the first SCI is greater than a configured or pre-configured threshold, etc.).

### Embodiment 10

FIG. 14 is a diagram showing a basic procedure of a method performed by user equipment according to Embodiment 10 of the present invention.

The method performed by user equipment according to Embodiment 10 of the present invention is described in detail below in conjunction with the basic procedure diagram shown in FIG. 14.

As shown in FIG. 14, in Embodiment 10 of the present invention, steps performed by the user equipment include the following steps.

In step S1001, the user equipment monitors first sidelink control information (SCI) transmitted by other user equipment.

Optionally, the first SCI includes indication information indicating that a transport block (TB) carried by a physical sidelink shared channel (PSSCH) corresponding to (or associated with or scheduled by) the first SCI is transmitted in a retransmission.

Optionally, one implementation of the indication information is indication by an indication field in the first SCI. For example, 0 indicates an initial transmission and 1 indicates a retransmission, or 1 indicates an initial transmission and 0 indicates a retransmission. Alternatively, another implementation is that the first SCI includes an indication field for indicating the number of transmissions. For example, the number of transmissions being set to 1 indicates the first retransmission and 2 indicates the second retransmission, or the number of transmissions being set to 2 indicates the first retransmission and 3 indicates the second retransmission. Alternatively, one implementation is implicit indication by a redundancy version (RV) in the first SCI. For example, RV=0 indicates an initial transmission, RV=2 indicates the first retransmission, RV=3 indicates the second retransmission, and RV=1 indicates the third retransmission. Implementations of this embodiment include but are not limited to the above implementations.

In step S1002, the user equipment determines a resource for the initial transmission of the TB carried by the PSSCH corresponding to the first SCI.

Optionally, the first SCI includes indication information gap of a time domain gap.

Optionally, the retransmission is the k^{th} retransmission, and the index of the initial transmission is (k^{th} retransmission index−gap*k).

In step S1003, the user equipment determines a reserved resource corresponding to the initial transmission.

Optionally, the reserved resource corresponding to the initial transmission is indicated by second SCI corresponding to the initial transmission.

Optionally, the second SCI includes an indication of a reserved resource interval (reservation interval).

Optionally, the user equipment determines that the index of the reserved resource corresponding to the initial transmission is (initial transmission index+reservation interval*time granularity). Optionally, the time granularity is 100 or 10, which is not limited in the present invention.

Alternatively,

optionally, the user equipment determines, according to the first SCI, the reserved resource corresponding to the initial transmission.

Optionally, the first SCI includes the indication of the reserved resource interval (reservation interval).

Optionally, the first SCI corresponds to the k^{th} retransmission, and the index of the reserved resource corresponding to the initial transmission is (k^{th} retransmission index−k*gap+reservation interval*time granularity). Optionally, the time granularity is 100 or 10, which is not limited in the present invention.

In step S1004, the user equipment excludes, from a candidate resource set or a resource set, a resource that overlaps with the reserved resource corresponding to the initial transmission determined by the user equipment. Overlapping means that time domain and frequency domain resources partially overlap or completely overlap. The user equipment selects a sidelink communication transmission resource from the unexcluded candidate resource set or resource set.

Optionally, a condition for the user equipment to exclude, from the candidate resource set or resource set, the resource that overlaps with the reserved resource corresponding to the initial transmission determined by the user equipment includes, but is not limited to, the following condition: overlapping with the reserved resource corresponding to the initial transmission. That is to say, the condition for the user equipment to exclude one or some resources from the candidate resource set or resource set may also include other conditions at the same time (satisfying the other conditions at the same time, for example, RSRP corresponding to the PSSCH corresponding to the first SCI is greater than a configured or pre-configured threshold, etc.).

### Example 11

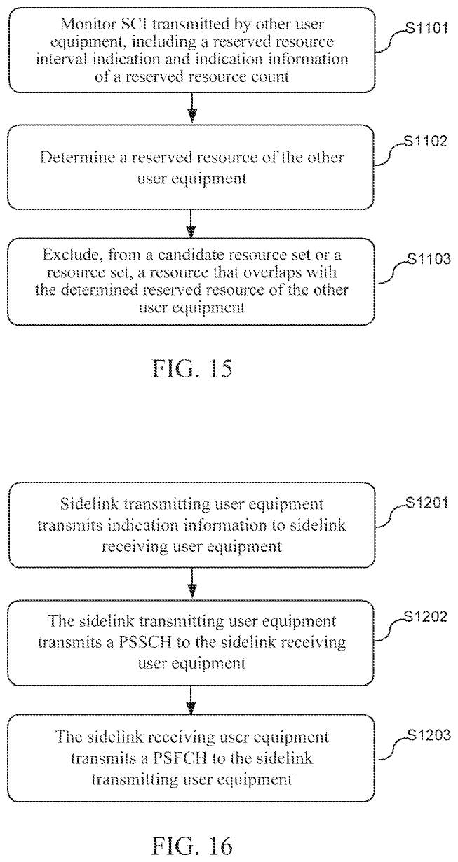

FIG. 15 is a diagram showing a basic procedure of a method performed by user equipment according to Embodiment 11 of the present invention.

The method performed by user equipment according to Embodiment 11 of the present invention is described in detail below in conjunction with the basic procedure diagram shown in FIG. 15.

As shown in FIG. 15, in Embodiment 11 of the present invention, steps performed by the user equipment include the following steps.

In step S1101, the user equipment monitors sidelink control information (SCI) transmitted by other user equipment.

Optionally, the SCI includes an indication of a reserved resource interval (reservation interval).

Optionally, the SCI includes indication of a number k of reserved resources.

Optionally, the indication of a number k of reserved resources indicates that the number of reserved resources located after the SCI in the time domain is k, or the indication of a number k of reserved resources indicates the number of remaining reserved resources.

Alternatively, optionally, the indication of a number k of reserved resources indicates that a resource of a PSSCH corresponding to the SCI is the k^{th} reserved resource.

Optionally, the maximum number of reserved resources is N, and the maximum number of reserved resources may be configured through RRC signaling, or pre-configured, or pre-defined, which is not limited in the present invention.

In step S1102, the user equipment determines a reserved resource of the other user equipment.

Optionally, the reserved resource of the other user equipment is a reserved resource located after the resource of the PSSCH corresponding to the SCI in the time domain.

Optionally, the reserved resource of the other user equipment is one or multiple reserved resources.

Optionally, the user equipment determines that the index of the first reserved resource located after the resource of the PSSCH corresponding to the SCI in the time domain is (index of resource of PSSCH corresponding to the SCI+reservation interval*time granularity), the index of the second reserved resource is (index of resource of PSSCH corresponding to the SCI+2*reservation interval*time granularity), and so on. The time granularity may be 100, 10, or other numerical values, which is not limited in the present invention. Alternatively, the user equipment determines that the index of the remaining first reserved resource is (index of resource of PSSCH corresponding to the SCI+reservation interval*time granularity), and determines that the index of the remaining second reserved resource is (index of resource of PSSCH corresponding to the SCI+2*reservation interval*time granularity).

In step S1103, the user equipment excludes, from a candidate resource set or a resource set, a resource that overlaps with the reserved resource of the other user equipment determined by the user equipment. Overlapping means that time domain and frequency domain resources partially overlap or completely overlap. The user equipment selects a sidelink communication transmission resource from the unexcluded candidate resource set or resource set.

Optionally, a condition for the user equipment to exclude, from the candidate resource set or resource set, the resource that overlaps with the reserved resource of the other user equipment determined by the user equipment includes, but is not limited to, the following condition: overlapping with the one or multiple reserved resources. That is to say, the condition for the user equipment to exclude one or some resources from the candidate resource set or resource set may also include other conditions at the same time (satisfying the other conditions at the same time, for example, RSRP corresponding to the PSSCH corresponding to the SCI is greater than a configured or pre-configured threshold, etc.).

### Embodiment 12

FIG. 16 is a diagram showing a basic procedure of a method performed by user equipment according to Embodiment 12 of the present invention.

The method performed by user equipment according to Embodiment 12 of the present invention is described in detail below in conjunction with the basic procedure diagram shown in FIG. 16.

As shown in FIG. 16, in Embodiment 12 of the present invention, steps performed by the user equipment include the following steps.

In step S1201, sidelink transmitting user equipment transmits indication information to sidelink receiving user equipment.

Optionally, the indication information includes a configuration period N of a PSFCH in a resource pool. Optionally, the configuration period N is in units of slots, and/or the indication information includes indication information of a feedback interval. Optionally, the indication information of the feedback interval indicates an interval k between the PSFCH and a corresponding PSSCH. Optionally, the feedback interval is in units of slots.

Optionally, the configuration period N is indicated by RRC signaling of a base station, or the configuration period N belongs to pre-configuration information of the sidelink transmitting user equipment.

Optionally, the feedback interval k is indicated by the RRC signaling of the base station, or the feedback interval k belongs to the pre-configuration information of the sidelink transmitting user equipment.

Optionally, a resource allocation mode of the sidelink transmitting user equipment is Transmission Mode 1 or Transmission Mode 2.

Optionally, the indication information is indicated by RRC signaling of a PC5 interface (PC5-RRC), or indicated by sidelink system information (a sidelink MIB or a sidelink SIB), or indicated by an S-SSB, which is not limited in the present invention.

In step S1202, the sidelink transmitting user equipment transmits the PSSCH to the sidelink receiving user equipment.

Optionally, the PSSCH is transmitted in slot #n. Alternatively, optionally, the PSSCH is transmitted in slot #n in the resource pool. Optionally, the slot index of the PSSCH in the resource pool is n.

In step S1203, the sidelink receiving user equipment transmits the PSFCH to the sidelink transmitting user equipment.

Optionally, the PSFCH is transmitted in slot #(n+k). Alternatively, optionally, the PSFCH is transmitted in slot #(n+k) in the resource pool. Optionally, the slot index of the PSFCH in the resource pool is n+k.

Optionally, the PSFCH is transmitted in slot #(n+k′), or optionally, in slot #(n+k′) in the resource pool. Optionally, the slot index of the PSFCH in the resource pool is n+k. k′ is indicated by the base station to the receiving user equipment through RRC signaling, or k′ belongs to the pre-configuration information of the receiving user equipment.

### Embodiment 13

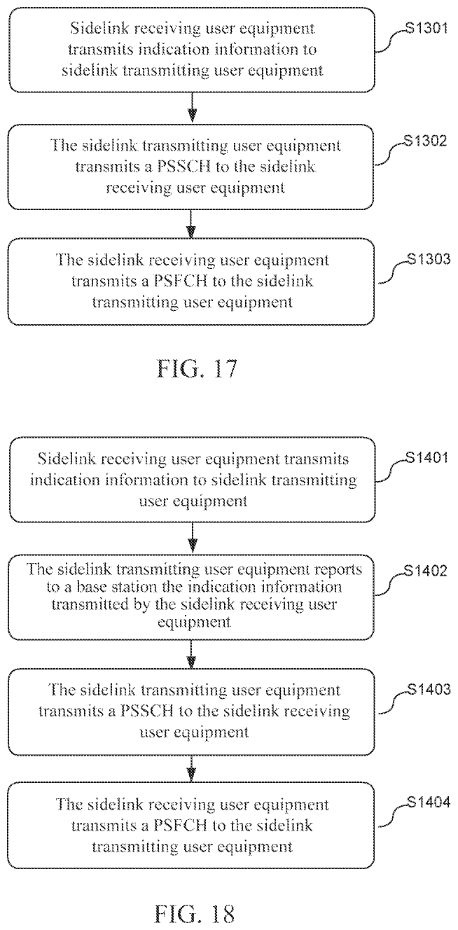

FIG. 17 is a diagram showing a basic procedure of a method performed by user equipment according to Embodiment 13 of the present invention.

The method performed by user equipment according to Embodiment 13 of the present invention is described in detail below in conjunction with the basic procedure diagram shown in FIG. 17.

As shown in FIG. 17, in Embodiment 13 of the present invention, steps performed by the user equipment include the following steps.

In step S1301, sidelink receiving user equipment transmits indication information to sidelink transmitting user equipment.

Optionally, the indication information includes a configuration period N of a PSFCH in a resource pool. Optionally, the configuration period N is in units of slots, and/or the indication information includes indication information of a feedback interval.

Optionally, the indication information of the feedback interval indicates an interval k between the PSFCH and a corresponding PSSCH. Optionally, the feedback interval is in units of slots.

Optionally, the configuration period N is indicated by RRC signaling of a base station, or the configuration period N belongs to pre-configuration information of the sidelink receiving user equipment.

Optionally, the feedback interval k is indicated by the RRC signaling of the base station, or the feedback interval k belongs to the pre-configuration information of the sidelink receiving user equipment.

Optionally, a resource allocation mode of the sidelink transmitting user equipment is Transmission Mode 1 or Transmission Mode 2.

Optionally, the sidelink receiving user equipment is out of network coverage (Out of Coverage) or in network coverage (In Coverage).

Optionally, the indication information is indicated by RRC signaling of a PC5 interface (PC5-RRC), or indicated by sidelink system information (a sidelink MIB or a sidelink SIB), or indicated by an S-SSB, which is not limited in the present invention.

In step S1302, the sidelink transmitting user equipment transmits the PSSCH to the sidelink receiving user equipment.

Optionally, the PSSCH is transmitted in slot #n. Alternatively,

optionally, the PSSCH is transmitted in slot #n in the resource pool. Optionally, the slot index of the PSSCH in the resource pool is n.

In step S1303, the sidelink receiving user equipment transmits the PSFCH to the sidelink transmitting user equipment.

Optionally, the PSFCH is transmitted in slot #(n+k). Alternatively, optionally, the PSFCH is transmitted in slot #(n+k) in the resource pool. Optionally, the slot index of the PSFCH in the resource pool is n+k.

### Embodiment 14

FIG. 18 is a diagram showing a basic procedure of a method performed by user equipment according to Embodiment 14 of the present invention.

The method performed by user equipment according to Embodiment 14 of the present invention is described in detail below in conjunction with the basic procedure diagram shown in FIG. 18.

As shown in FIG. 18, in Embodiment 14 of the present invention, steps performed by the user equipment include the following steps.

In step S1401, sidelink receiving user equipment transmits indication information to sidelink transmitting user equipment.

Optionally, the indication information includes a configuration period N of a PSFCH in a resource pool. Optionally, the configuration period N is in units of slots, and/or the indication information includes indication information of a feedback interval. Optionally, the indication information of the feedback interval indicates an interval k between the PSFCH and a corresponding PSSCH. Optionally, the feedback interval is in units of slots.

Optionally, the configuration period N is indicated by RRC signaling of a base station, or the configuration period N belongs to pre-configuration information of the sidelink receiving user equipment.

Optionally, the feedback interval k is indicated by the RRC signaling of the base station, or the feedback interval k belongs to the pre-configuration information of the sidelink receiving user equipment.

Optionally, a resource allocation mode of the sidelink transmitting user equipment is Transmission Mode 1 or Transmission Mode 2.

Optionally, the sidelink receiving user equipment is out of network coverage (Out of Coverage) or in network coverage (In Coverage).

Optionally, the indication information is indicated by RRC signaling of a PC5 interface (PC5-RRC), or indicated by sidelink system information (a sidelink MIB or a sidelink SIB), or indicated by an S-SSB, which is not limited in the present invention.

In step S1402, the sidelink transmitting user equipment reports to the base station the indication information transmitted by the sidelink receiving user equipment.

Optionally, the indication information is reported through a BSR, or a MAC CE, or a PUCCH, or a PUSCH, or an SR, which is not limited in the present invention.

In step S1403, the sidelink transmitting user equipment transmits the PSSCH to the sidelink receiving user equipment.

Optionally, the PSSCH is transmitted in slot #n. Alternatively,

optionally, the PSSCH is transmitted in slot #n in the resource pool. Optionally, the slot index of the PSSCH in the resource pool is n.

In step S1404, the sidelink receiving user equipment transmits the PSFCH to the sidelink transmitting user equipment.

Optionally, the PSFCH is transmitted in slot #(n+k). Alternatively, optionally, the PSFCH is transmitted in slot #(n+k) in the resource pool. Optionally, the slot index of the PSFCH in the resource pool is n+k.

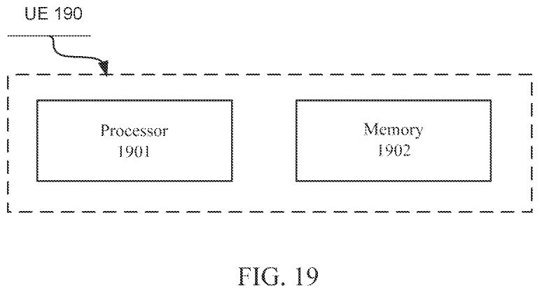

FIG. 19 is a block diagram showing user equipment (UE) involved in the present invention. As shown in FIG. 19, the user equipment (UE) 190 includes a processor 1901 and a memory 1902. The processor 1901 may include, for example, a microprocessor, a microcontroller, an embedded processor, and the like. The memory 1902 may include, for example, a volatile memory (such as a random access memory (RAM)), a hard disk drive (HDD), a non-volatile memory (such as a flash memory), or other memories. The memory 1902 stores program instructions. The instructions, when run by the processor 1901, can perform the foregoing method performed by user equipment as described in detail in the present invention.

The methods and related devices according to the present invention have been described above in conjunction with the preferred embodiments. It should be understood by those skilled in the art that the methods shown above are only exemplary, and the above-described embodiments can be combined with one another as long as no contradiction arises. The method of the present invention is not limited to steps or sequences illustrated above. The network node and the user equipment illustrated above may include more modules; for example, they may further include modules which can be developed or developed in the future to be applied to modules of a base station, an MME, or UE. Various identifiers shown above are only exemplary and are not intended to be limiting. The present invention is not limited to specific information elements serving as examples of these identifiers. Those skilled in the art can make various alterations and modifications according to the teachings of the illustrated embodiments.

It should be understood that the embodiments above of the present invention can be implemented by software, hardware or a combination of the software and the hardware. For example, various components of the base station and user equipment in the above embodiments can be implemented by multiple devices, and these devices include, but are not limited to: an analog circuit device, a digital circuit device, a digital signal processing (DSP) circuit, a programmable processor, an application specific integrated circuit (ASIC), a field programmable gate array (FPGA), and a complex programmable logic device (CPLD), and the like.

In this application, the “base station” may refer to a mobile communication data and control exchange center with large transmission power and a wide coverage area, including functions such as resource allocation and scheduling, data reception and transmission. “User equipment” may refer to a user mobile terminal, for example, including terminal devices that can communicate with a base station or a micro base station wirelessly, such as a mobile phone, a laptop computer, and the like.

Moreover, the embodiments of the present invention disclosed herein can be implemented on a computer program product. More particularly, the computer program product is a product as follows: a product having a computer readable medium encoded with computer program logic thereon, when being executed on a computing equipment, the computer program logic provides related operations to implement the technical solution of the prevent invention. When being executed on at least one processor of a computing system, the computer program logic enables the processor to execute the operations (methods) described in the embodiments of the present invention. Such setting of the present invention is typically provided as software, codes and/or other data structures provided or encoded on the computer readable medium, e.g., an optical medium (e.g., compact disc read-only memory (CD-ROM)), a flexible disk or a hard disk and the like, or other media such as firmware or micro codes on one or more read-only memory (ROM) or random access memory (RAM) or programmable read-only memory (PROM) chips, or a downloadable software image, a shared database and the like in one or more modules. The software or the firmware or such configuration can be installed on the computing equipment, so that one or more processors in the computing equipment execute the technical solution described in the embodiments of the present invention.

In addition, each functional module or each feature of the base station device and the terminal device used in each of the above embodiments may be implemented or executed by a circuit, which is usually one or more integrated circuits. Circuits designed to execute various functions described in this description may include general-purpose processors, digital signal processors (DSPs), application specific integrated circuits (ASICs) or general-purpose integrated circuits, field programmable gate arrays (FPGAs) or other programmable logic devices, discrete gates or transistor logic, or discrete hardware components, or any combination of the above. The general-purpose processor may be a microprocessor; or the processor may be an existing processor, a controller, a microcontroller, or a state machine. The above-mentioned general purpose processor or each circuit may be configured with a digital circuit or may be configured with a logic circuit. In addition, when an advanced technology that can replace current integrated circuits emerges due to advances in semiconductor technology, the present invention may also use integrated circuits obtained using this advanced technology.

Although the present invention is already illustrated above in conjunction with the preferred embodiments of the present invention, those skilled in the art should understand that, without departing from the spirit and scope of the present invention, various modifications, replacements and changes can be made to the present invention. Therefore, the present invention should not be defined by the above embodiments, but should be defined by the appended claims and equivalents thereof.

1-9. (canceled)

10. User equipment, comprising:
reception circuitry configured to monitor and receive sidelink control information (SCI) indicating a number K of one or more reserved resources in time domain after the SCI, wherein a maximum of the number K is determined by Radio Resource Control (RRC) signaling; and
a processor configured to determine the one or more reserved resources based on the SCI, and to exclude at least one resource from candidate resources, wherein the at least one resource is determined based on at least the one or more reserved resources, and candidate resources excluding the at least one resource are resources from which a sidelink communication transmission resource is selected.

11. A method performed by user equipment, the method comprising:
monitoring and receiving sidelink control information (SCI) indicating a number K of one or more reserved resources in time domain after the SCI, wherein a maximum of the number K is determined by Radio Resource Control (RRC) signaling; and
determining the one or more reserved resources based on the SCI; and
excluding at least one resource from candidate resources, wherein the at least one resource is determined based on at least the one or more reserved resources, and candidate resources excluding the at least one resource are resources from which a sidelink communication transmission resource is selected.
